(19) United States
(12) Patent Application Publication
(10) Pub. No.: US 2008/0272664 A1
(43) Pub. Date: Nov. 6, 2008

(54) PERMANENT MAGNET ELECTRO-MECHANICAL DEVICE PROVIDING MOTOR/GENERATOR FUNCTIONS

(76) Inventor: Charles J. FLYNN, Greenwood, MO (US)

Correspondence Address: WILMERHALE/BOSTON, 60 STATE STREET, BOSTON, MA, 02109, US

(21) Appl. No.: 12/057,285

(22) Filed: Mar. 27, 2008

Related U.S. Application Data
(60) Provisional application No. 60/908,297, filed on Mar. 27, 2007.
(60) Provisional application No. 60/938,111, filed on May 15, 2007.
(60) Provisional application No. 60/938,115, filed on May 15, 2007.
(60) Provisional application No. 60/961,573, filed on Jul. 23, 2007.
(60) Provisional application No. 60/966,595, filed on Aug. 29, 2007.
(60) Provisional application No. 60/998,676, filed on Oct. 12, 2007.
(60) Provisional application No. 60/987,289, filed on Nov. 12, 2007.

(51) Int. Cl. H02K 21/38

(52) U.S. Cl. 310/154.01

(57) ABSTRACT

Apparatus and methods for providing and controlling a permanent magnet electro-mechanical device that functions as a motor or generator are disclosed. The electro-mechanical device uses control coils to steer magnetic flux of permanent magnets placed between stator segments. The control coils can be wound around the bridge of a stator segment, the poles of a stator segment or both. The electro-mechanical device can be single phase or multi-phase and can include controllers, sensors, a thermal/electrical insulating structure, or a reluctance gap. The stator poles are grouped and designed with an angular spacing that is based on the number of permanent magnets. The electro-mechanical device has a higher power density than conventional motors and generators and operates more efficiently, while operating at cooler temperatures.

### CROSS-REFERENCE TO RELATED APPLICATION

This application claims benefit under 35 U.S.C. § 119(e) of U.S. Provisional Patent Application No. 60/908,297, entitled “Permanent Magnet Salient Pole Motor with Active Stator Reluctance Gap,” filed Mar. 27, 2007; U.S. Provisional Patent Application No. 60/938,111, entitled “Switched Reluctance Motor Using Stator Mounted Permanent Magnet and Controlling the Operation Thereof,” filed May 15, 2007; U.S. Provisional Application No. 60/938,115, entitled “A Rotating Machine with Stator Mounted Permanent Magnets for Producing Mechanical or Electrical Power”, filed May 15, 2007; U.S. Provisional Application No. 60/961,573, entitled “An Electric Motor Using Stator Mounted Permanent Magnets and Controlling The Operation Thereof”, filed Jul. 23, 2007; U.S. Provisional Application No. 60/966,595, entitled “Controller for Stator Mounted Permanent Magnet Motor”, filed Aug. 29, 2007; U.S. Provisional Application No. 60/998,676, entitled “Multiphase Motor/Generator with Stator Mounted Permanent Magnets”, filed Oct. 12, 2007; and U.S. Provisional Application No. 60/987,289, entitled “Multiphase Motor/Generator with Stator Mounted Permanent Magnets”, filed Nov. 12, 2007, all of which are hereby incorporated by reference herein in their entireties.

### TECHNICAL FIELD OF THE DISCLOSURE

Apparatus and methods for providing and controlling a permanent magnet electro-mechanical device that functions as a motor or generator are disclosed.

### BACKGROUND OF THE DISCLOSURE

With few exceptions the basic operating principles for electric motors and generators have not changed much over the past 100 years. With the development of high energy or high coercive force permanent magnets the power density and efficiency of electric motors was increased over the then state of the art motor technologies by replacing the field coils in brush motors or armature coils in brush-less motors with permanent magnets. The permanent magnets require less space and typically weigh less than the copper windings they replaced and reduce the 12R losses of the motor's total electrical system.

Replacing coils with permanent magnets introduced a new motor design challenge. The field of the permanent magnets cannot be ‘turned off,’ which introduces high cogging torques at start-up. The constant magnetic flux also causes the motor's back electromotive force to become linear with speed, resulting in a linear speed to torque relationship, which reduces the efficiency of operation when the motor is producing peak power. Most of the approaches to control the efficiency at peak output power for permanent magnet motors have been directed toward electronically controlling the phase excitation angles and current. This electronic control approach works well for modifying the linear speed to torque relation to produce a more hyperbolic speed to torque relationship, but requires increasing the size and ultimately the weight of the controlled motor. This controller approach results in a counter productive exercise for the most part because while permanent magnets were used to reduce motor size and weight, in order to optimize efficiency at peak power, the motor size and weight is increased to that of motors using copper windings. By having to resize the motor, some of the benefits of using permanent magnets in the motor are negated.

### SUMMARY OF THE DISCLOSURE

This disclosure relates to a permanent magnet electro-mechanical device that functions as a motor or generator that includes control coils, a rotor, and a uses an angular arrangement of permanent magnets placed in the stator portion. The arrangement and design of stator segments is guided by an angular spacing relative to the number of permanent magnets used in the electro-mechanical device. The control coils are used to steer magnetic flux from the permanent magnets onto the rotor or can produce power when the rotor is turned with an external torque.

In one aspect, an electro-mechanical device includes a rotor having a plurality of poles arranged about a central axis of rotation, and a stator aligned with the rotor and including a first stator segment, a second stator segment, and a permanent magnet which has north and south pole faces and is positioned between the first and second stator segments, wherein the first stator segment includes a left section, a right section, and a bridge section separating the left and right sections of the first stator segment, wherein the right section of the first stator segment is adjacent to a first pole face of the first permanent magnet and includes a first reluctance bridge extension and includes a stator pole that extends towards the rotor, wherein the second stator segment includes a left section, a right section, and a bridge section separating the right and left section of the second stator segment, wherein the left section of the second stator segment is adjacent to a second pole face of the first permanent magnet and includes a second reluctance bridge extension and includes a stator pole that extends towards the rotor, and wherein the first and second reluctance bridge extensions extend towards each other and provide a magnetic flux path bridging the north and south poles of the first permanent magnet.

In another aspect, an electro-mechanical device includes a rotor having a plurality of poles arranged about a central axis of rotation; and a stator aligned with the rotor and including a plurality of stator segments arranged on a path that circumscribes the central axis of rotation, said stator also including a plurality of permanent magnets, each of which has north and south pole faces and is positioned between a different pair of stator segments among the plurality of stator segments, wherein the permanent magnets are serially arranged along the path with pole faces oriented north to north and south to south, wherein the plurality of stator segments includes a first stator segment and a second stator segment and a first permanent magnet between the first and second stator segments, wherein the first stator segment includes a left section, a right section, and a bridge section separating the right and left sections of the first stator segment, wherein the right section of the first stator segment is adjacent to a first face of the first permanent magnet and includes a first reluctance bridge extension and a stator pole that extends towards the rotor, wherein the second stator segment includes a left section, a right section, and a bridge section separating the right and left sections of the second stator segment, wherein the left section of the second stator segment is adjacent to a second face of the first permanent magnet and includes a second reluctance bridge extension and a stator pole that extends towards the rotor, and wherein the first and second reluctance bridge extensions extend toward each other and provide a path for a portion of the magnetic flux of the first permanent magnet to flow between the first and second stator segments.

In yet another aspect, an electro-mechanical device includes a rotor having a plurality of poles arranged about a central axis of rotation, a stator including a plurality of stator segments arranged on a path that circumscribes the axis of rotation, said stator also including a plurality of permanent magnets, each of which has north and south pole faces and is positioned between a different pair of stator segments among the plurality of stator segments, wherein each stator segment has at least two stator poles extending toward the rotor, and a sensor mounted near a selected one of the plurality of permanent magnets for detecting during operation changes in a magnetic flux produced by that selected permanent magnet.

In another aspect, an electro-mechanical device includes a rotor having a plurality of poles arranged about a central axis of rotation, a stator including a plurality of poles extending toward the rotor, a plurality of permanent magnets, and a sensor mounted near a selected one of the permanent magnets for detecting changes in flux produced by the selected permanent magnet during operation of the device.

In yet another aspect, an electro-mechanical device includes a rotor having a plurality of poles arranged about a central axis of rotation, and a stator including N stator segments arranged on a path that circumscribes the axis of rotation, said stator also including N permanent magnets, each of which has north and south pole faces and is positioned between a different pair of stator segments among the N stator segments, wherein each stator segment comprises two stator poles joined by a bridge section and a coil wound around the bridge section, wherein the two stator poles of each stator segment extend toward the rotor, wherein the N permanent magnets are serially arranged in the stator with pole faces aligned north to north and south to south, and wherein N is an even integer that is greater than 2.

In another aspect, an electro-mechanical device includes a rotor having a plurality of poles arranged about a central axis of rotation, and a stator including N stator segments arranged on a circle that circumscribes the axis of rotation, said stator also including N permanent magnets, each of which has north and south pole faces and is positioned between a different pair of stator segments among the N stator segments, wherein each stator segment has two stator poles that extend toward the rotor and a coil wound around each of the two stator poles, wherein the N permanent magnets are serially arranged in the stator with pole faces aligned north to north and south to south, wherein N is an even integer that is greater than 1, and wherein the poles of the plurality of segments are arranged around the axis of rotation with unequal angular spacing.

In yet another aspect, an electro-mechanical device includes a rotor having a plurality of poles arranged about a central axis of rotation, and a stator including N stator segments arranged on a circle that circumscribes the axis of rotation, said stator also including N permanent magnets, each of which has north and south pole faces and is positioned between a different pair of stator segments among the N stator segments, wherein each stator segment comprises two stator poles joined by a bridge section, a coil wound around each of the two stator poles of that stator segment, and a coil wound around the bridge section, wherein the two stator poles of each stator segment extend toward the rotor, wherein the N permanent magnets are serially arranged in the stator with pole faces aligned north to north and south to south, and wherein N is an even integer that is greater than 1.

In another aspect, an electro-mechanical device includes a rotor having a plurality of poles arranged about a central axis of rotation, and a stator including a first stator segment and a second stator segment and a permanent magnet between the first and second stator segments, wherein each of the first and second stator segments includes two poles extending toward the rotor and a bridge section joining the two poles, the stator further comprising an insulating structure that thermally or electrically isolates the permanent magnet from the first and second stator segments relative to an arrangement in which the permanent magnet directly contacts the first and second stator segments.

### BRIEF DESCRIPTION OF THE DRAWINGS

FIG. 1 is a diagram illustrating a bridge wound permanent magnet electro-mechanical device;

FIG. 2 is a diagram illustrating placement of components on a bridge wound permanent magnet electro-mechanical device;

FIG. 3 is a diagram illustrating a control coil used in the permanent magnet electro-mechanical device;

FIGS. 4A-4D are wiring diagrams illustrating various wire interconnections for the bridge wound permanent magnet electro-mechanical device;

FIG. 5 is a schematic diagram illustrating an H bridge for alternating the direction of current flow in the control coils;

FIGS. 6 and 7 are schematic diagrams illustrating current flow through an H bridge;

FIG. 8 is a diagram illustrating a bifilar winding for a control coil of the electro-mechanical device;

FIGS. 9-12 are wiring diagrams illustrating various bifilar wire interconnections for the permanent magnet electro-mechanical device;

FIGS. 13-15 are diagrams illustrating control mechanism for a bifilar wound electro-mechanical device;

FIG. 16 is a diagram illustrating a series/parallel switching mechanism for a permanent magnet electro-mechanical device;

FIG. 17 is a diagram illustrating an electronic switching mechanism for a permanent magnet electro-mechanical device;

FIG. 18 is a diagram illustrating a commutator and series/parallel switching mechanism for a permanent magnet electro-mechanical device;

FIG. 19 is a diagram illustrating an H bridge and a series/parallel switching mechanism for a permanent magnet electro-mechanical device;

FIGS. 20-22 are diagrams illustrating operation of an embodiment of the electro-mechanical device;

FIG. 23 is a diagram illustrating a pole wound embodiment of the electro-mechanical device;

FIG. 24 is a diagram illustrating placement of components on a pole wound electro-mechanical device;

FIGS. 25-27 are wiring diagrams illustrating various wire interconnections for the pole wound permanent magnet electro-mechanical device;

FIG. 28 is a diagram illustrating a brush and slip ring commutator for a pole wound electro-mechanical device;

FIG. 29 is a diagram illustrating a brush and slip ring commutator with pulse width modulation capability for a pole wound electro-mechanical device;

FIG. 30 is a diagram illustrating an electronic switching mechanism for a pole wound electro-mechanical device;

FIGS. 31 and 32 are diagrams illustrating operation of the pole wound permanent magnet electro-mechanical device;

FIGS. 33 and 34 are diagrams illustrating a pole and bridge wound permanent magnet electro-mechanical device;

FIGS. 35 and 36 are diagrams illustrating operation of the pole and bridge wound permanent magnet electro-mechanical device;

FIG. 37 is a diagram illustrating a multi-phase pole wound electro-mechanical device;

FIG. 38 is a diagram illustrating placement of components on a multi-phase pole wound electro-mechanical device;

FIG. 39 is a diagram illustrating polarities on a multi-phase pole wound electro-mechanical device;

FIG. 40 is a diagram illustrating a control mechanism for a multi-phase pole wound electro-mechanical device;

FIG. 41 is a diagram illustrating operation of a multi-phase pole wound electro-mechanical device;

FIG. 42 is a timing diagram illustrating timing relationships for control coils of a multi-phase pole wound electro-mechanical device;

FIGS. 43-46 are diagrams illustrating placement of sensors and circuitry for the sensor of various embodiments of an electro-mechanical device;

FIG. 47 is a diagram illustrating an electrical and/or thermal insulating barrier in a stator segment of an electro-mechanical device;

FIG. 48 is a diagram illustrating a hub embodiment of the electro-mechanical device;

FIGS. 49 and 50 are diagrams illustrating the addition of a reluctance bridge and gap to a electro-mechanical device;

FIGS. 51-55 are diagrams illustrating a control coil wound around the reluctance bridge and gap of the electro-mechanical device; and

FIG. 56 is a diagram illustrating an electro-mechanical device with coil wound reluctance bridges and gaps.

### DETAILED DESCRIPTION OF THE DISCLOSURE

An apparatus, method and means for providing a permanent magnet electro-mechanical device that functions as a motor or generator are disclosed. The electro-mechanical device includes control coils, a rotor, and uses an angular arrangement of permanent magnets placed in the stator portion. The electro-mechanical device uses control coils to steer magnetic flux of permanent magnets placed between stator segments and the control coils can be used to generate power when an external torque is applied to the rotor. The control coils can be wound around the bridge of a stator segment, the poles of a stator segment or both. The electro-mechanical device can be single phase or multi-phase, and can include controllers, sensors, a thermal/electrical insulating structure, or a reluctance gap. The disclosed electro-mechanical device provides a higher power density than conventional motors and generators. The electro-mechanical device can also operate more efficiently than conventional motors and generators, while operating at cooler temperatures.

FIG. 1 shows an embodiment of a single phase electro-mechanical device with stator bridge windings. The electro-mechanical device of FIG. 1 is comprised of six stator segments 1, six permanent magnets 2, a rotor 4 and six control coils 10-a through 10-f. Each stator segment 1 includes a stator bridge 3 that separates two salient stator poles 6. The six permanent magnets 2 are placed between each stator segment 1 with their magnetic fields 7 opposing. That is, on either side of a stator segment 1, the same magnetic faces (north or south) of the permanent magnets 2 are adjacent to one another. Control coils 10-a through 10-f are wound on each stator bridge 3. The rotor 4 includes fifteen salient rotor poles 5 and is mounted to rotate about a central axis of rotation 8 on shaft 9. Each salient rotor pole may protrude slightly from the rotor. The six control coils 10-a through 10-f can be either single filament or bifilar wound. The term control coils is used for the motor phase coils since their function is to couple with and redirect the magnetic flux produced by permanent magnets, they could also be called ‘phase windings’ or just coils. This is true for all of the embodiments disclosed herein.

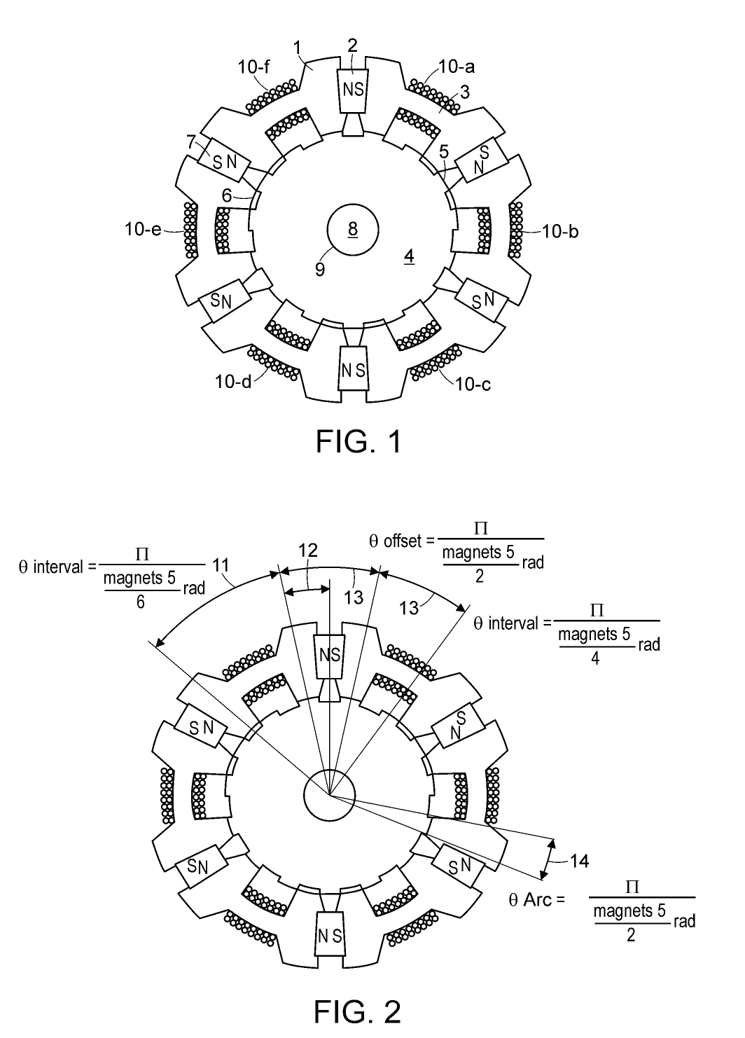

FIG. 2 illustrates how the various components of the electro-mechanical device can be placed in an embodiment where control coils 10-a through 10-f are wound on the stator bridge 3. This embodiment places stator poles 6 in an angular spaced manner to produce a pole arc and pole area with the least number of phase switching periods to rotate the rotor one revolution. The stator poles are arranged in multiple pole pairs where the poles in the pole pair are separated by an angle 11 and the pole pairs are separated by an angle 13.

The angular interval between stator poles comprising one pole pair (angle 11 of FIG. 2) is a derivative of the number of magnets placed in the stator and is given in radians by:

$${θ}_{interval} = \frac{π}{( \frac{magnets \cdot 5}{6} )}$$

And the angular intervals by which the pole pairs are separated (angle 13 of FIG. 2) are also a derivative of the number of magnets in the stator and are given in radians by:

$${θ}_{interval} = \frac{π}{( \frac{magnets \cdot 5}{4} )}$$

The rotor pole arc, rotor reluctance gap arc, a stator pole arc, and the angular offset of a stator pole in a pole pair from a line originating at the rotor's central axis of rotation and intersecting the center of one of the permanent magnets (angle 12 of FIG. 2) are all equal and are also a derivative of the number of magnets in the stator and are given in radians by:

$$θ = \frac{π}{( \frac{magnets \cdot 5}{4} )}$$

In some motor applications, such as electric vehicle applications, it is desirable to produce high torque during acceleration and lower torque required for constant vehicle speed. In some generator applications, where the generator speed is variable a first stage current and voltage control is desirable. Both of these functions can be accomplished by electronically or electromechanically switching the control coils to be either in series, parallel or in various combinations thereof which lowers or raises inductance and resistance depending upon the series parallel configuration of the control coils. The control of the control coil configurations can be functions of all or a mix of the current, voltage and generator speed using discrete electronic components or by a microprocessor based controller.

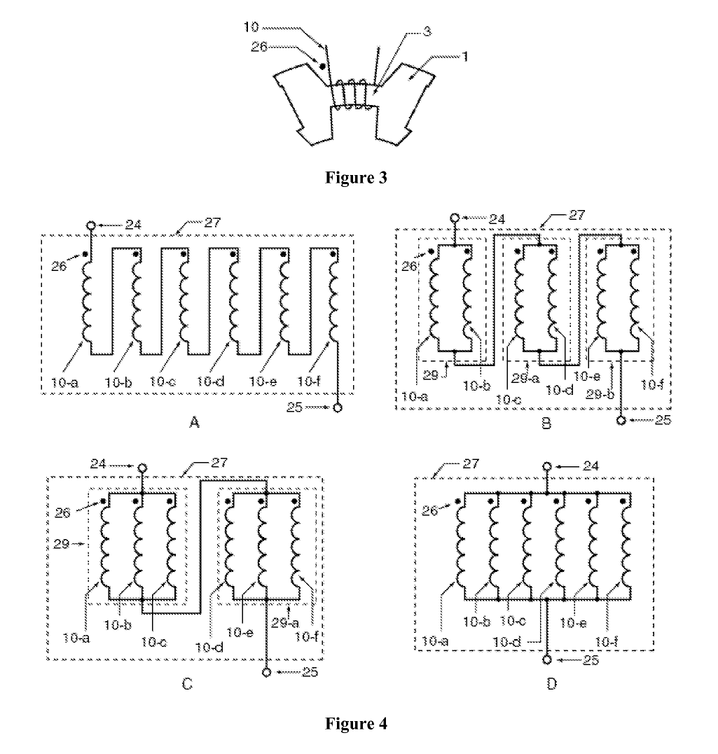

FIG. 3 shows a single filament winding 10 forming a control coil wound on a stator bridge 3 of a stator segment 1 of the bridge wound electro-mechanical device. A start lead 26 is identified for the winding to provide a reference for current flows into or out of this start lead 26. Based on the current flows, the direction of the magnetic polarity produced by the winding can be determined.

FIGS. 4A-4D show various ways the six single filament control coils 10-a through 10-f can be electrically connected on the bridge wound electro-mechanical device. For ease of explanation, a control coil group 27 is used to represent any of the various ways to wire the control coils 10-a through 10-f and two common connections 24 and 25 are used to show how control coil group 27 can be coupled to an electrical power source. FIG. 4A shows all of the control coils 10-a through 10-f connected electrically in series. FIG. 4B shows the control coil sets of 29-a, 29-b and 29-c, which respectively include control coils 10-a and 10-b, 10-c and 10-d, and 10-e and 10-f electrically connected in parallel. The control coil sets of 29-a, 29-b and 29-c are electrically connected in series. FIG. 4C shows the control coil sets 29-a and 29-b, which respectively include control coils 10-a, 10-b and 10-c as well as control coils 10d, 10-e and 10-f connected electrically in parallel. The control coil sets of 29-a and 29-b are electrically connected in series. FIG. 4D shows all of the control coils 10-a through 10-f connected electrically in parallel.

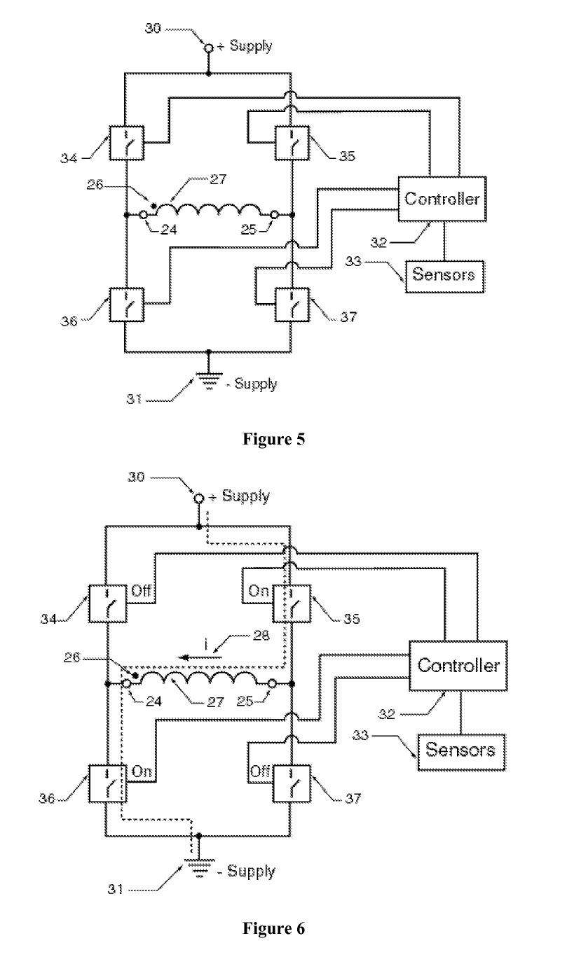

FIG. 5 shows an H bridge for alternating the direction of current flow through single filament bridge wound control coils of the electro-mechanical device. The H bridge includes two high side switches 34 and 35 and two low side switches 36 and 37. The H bridge switches 34, 35, 36, and 37 are coupled to the common connections 24 and 25 of control coil group 27. As mentioned above, control coil group 27 can be wired in a variety of ways. Common control coil connection 24 is identified as the start lead connection 26 for reference purposes. The H bridge switches 34 through 37 are coupled to a controller 32 that turns H bridge switches ‘on’ or ‘off’ depending upon information received from sensors 33. The direction in which electrical power flows through the control coil group 27 depends upon which one of the high side switches 34 or 35 and which one of the low side switches 36 or 37 are turned ‘on’. Positive 30 and negative 31H bridge electrical connections are connected to an electrical power source. The information provided from sensors 33 includes rotor position, current measurements, and voltage measurements. The sensors 33 can be implemented with Hall Effect sensors, optical components, or circuit components such as op amp comparators and the like to supply control signals to controller 32. The controller can be comprised of discrete electronic components, a micro-controller or a microprocessor. The H bridge switches 34 through 37 can be IGBTs power MosFets or similar switches.

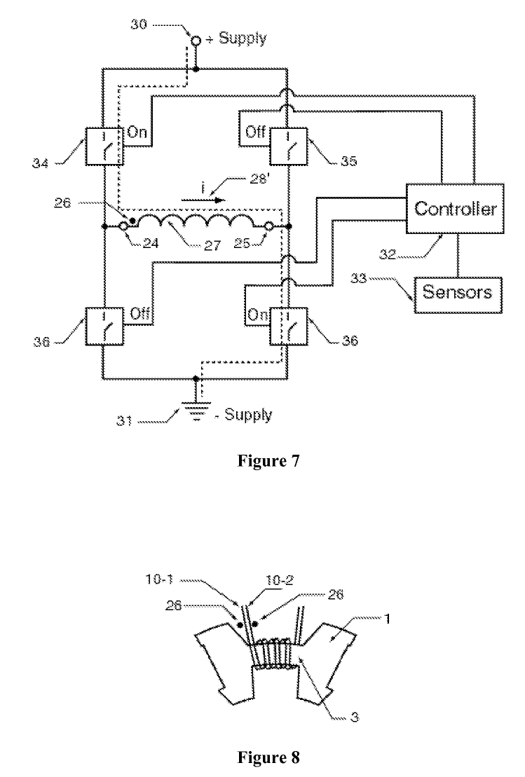

FIG. 6 shows the H bridge conducting current in the direction 28, with respect to the control coil start lead 26, into the common connections 24 and 25 of the control coil group 27. To produce current in the direction 28, H bridge switches 35 and 36 are turned ‘on’ or conducting while switches 34 and 37 are held off. FIG. 7 shows the H bridge conducting current in the opposite direction 28′, with respect to the control coil start lead 26, into control coil group 27. To produce current in the direction 28′, H bridge switches 34 and 36 are ‘on’ or conducting while switches 35 and 36 are held off.

FIG. 8 shows a bifilar winding for a control coil with a first filament 10-1 and a second filament 10-2 forming a control coil wound on the stator bridge 3 of a stator segment 1. A bifilar wound electromechanical device may be used instead of a single filament because in bifilar each filament can carry current in one direction. Rather than switch current flow through a single filament, the two bifilar filaments are electrically connected to carry current flow opposite one another with respect to start leads 26. Using a bifilar wiring can reduce the number of switches used to change the polarity of the control coils compared to a single filament. A start lead 26 is identified for each winding to provide a reference for current flows into or out of this start lead 26. Based on the current flows, the direction of the magnetic polarity produced by the bifilar winding can be determined.

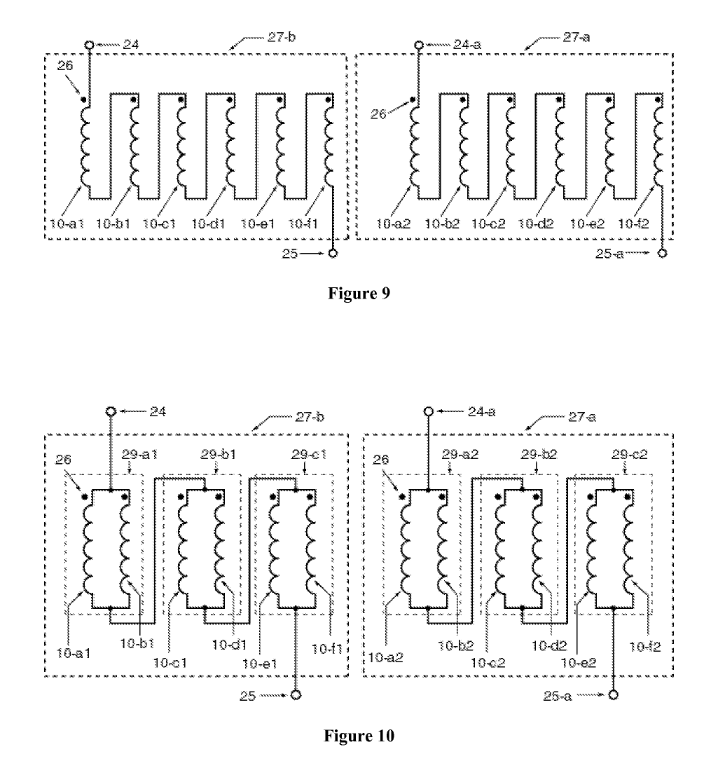

FIGS. 9-12 show the various ways the first filament 10-1 and the second filament 10-2 can be used in bridge wound electro-mechanical device. Two bifilar control coil filament groups 27-b and 27-a are used to represent different wiring arrangements for bifilar wound control coils 10-a1 through 10-f1, and 10-a2 through 10-f2, respectively. The first bifilar wound control coil filament group 27-b has common electrical power connections 24 and 25. The second bifilar wound control coil filament group 27-a has two common electrical power connections 24-a and 25-a. Electrical power flows into the bifilar wound control coils from an electrical power controller through these common connections. The start lead 26 for each control coil group is identified for determining current direction.

FIG. 9 shows the bifilar wound control coils of 10-a1 through 10-f1 of and 10-a2 and 10-f2 of control coil filament groups 27-b and 27-a connected electrically in series. FIG. 10 shows the bifilar wound control coils of control coil filament groups 27-b and 27-a connected electrically in a pairs parallel with these pairs in a series arrangement. Bifilar wound control coils 10-a1 and 10-b1, 10-c1 and 10-d1, and 10-e1 and 10-f1 are electrically connected in parallel and respectively form three control coil sets 29-a1, 29-b1, and 29-c1. The three control coil sets 29-a1, 29-b1 and 29-c1 are electrically connected in series. Bifilar wound control coils 10-a2 and 10-b2, 10-c2 and 10-d2, and 10-e2 and 10-f2 are electrically connected in parallel and respectively form three control coil sets 29-a2, 29-b2, and 29-c2. The three control coil sets 29-a2, 29-b2 and 29-c2 are electrically connected in series.

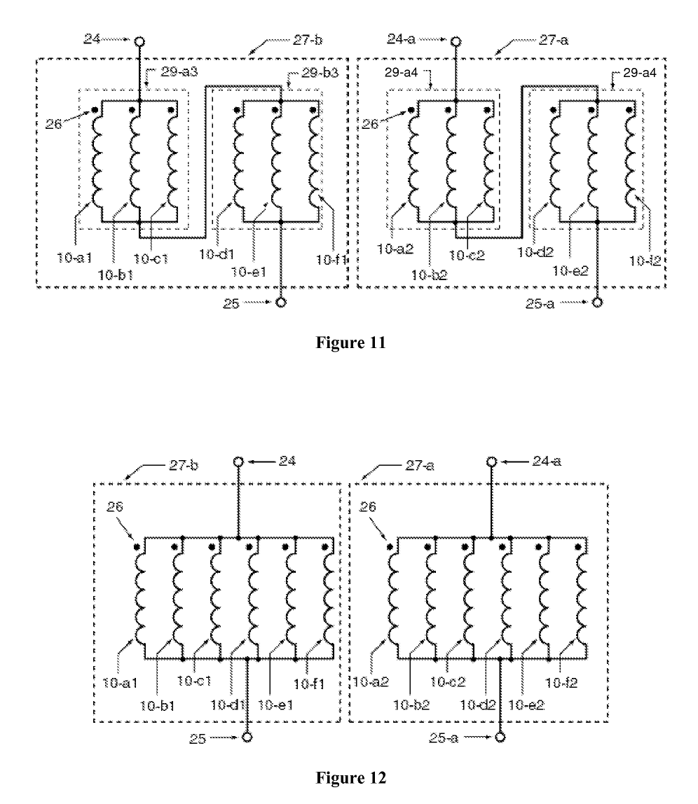

FIG. 11 shows the bifilar wound control coils of control coil filament groups 27-b and 27-a electrically connected in a partial series and parallel arrangement. Bifilar wound control coils 10-a1, 10-b1 and 10-c1, and 10-a2, 10-b2 and 10-c2 are electrically connected in parallel to respectively form control coil sets 29-a3 and 29-a4. Bifilar wound control coils 10-d1, 10-e1 and 10-f1, and 10-d2, 110-e2 and 10-f2 are electrically connected in parallel to respectively form control coil sets 29-b3 and 29-b4. Control coils sets 29-a3 and 29-b3 as well as control coil sets 29-a4 and 29-b4 are electrically connected in series.

FIG. 12 shows the bifilar wound control coils of control coil filament groups 27-b and 27-a electrically connected in a parallel arrangement. Bifilar wound control coils 10-a1 through 10-f1 and bifilar wound control coils 10-a2 through 10-f2 are electrically connected in parallel.

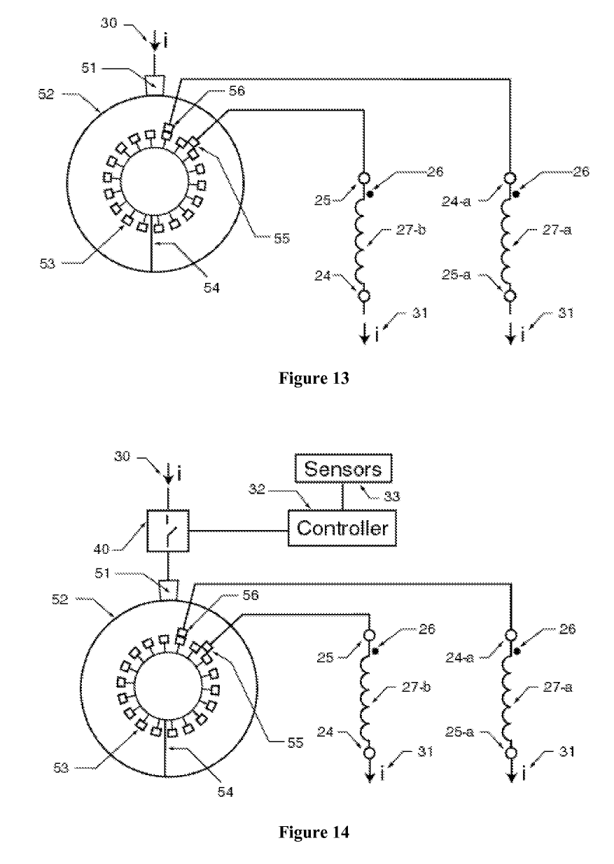

FIGS. 13 through 15 shows several methods for controlling a bifilar bridge wound electro-mechanical device. FIG. 13 shows a brush and slip ring commutator that controls through which of the two filaments forming a bifilar wound control coil electrical power flows from an electrical power supply. The control coil filament groups 27-b and 27-a can be electrically wired in one of the configurations described in FIG. 9, 10, 11 or 12. For the brush and slip ring commutator, electrical power from a power supply flows in the direction 30 into brush 51 which transfers this electrical power into slip ring 52 which transfers this electrical power 54 to a segmented commutator 53. The electrical power is then transferred from the segmented commutator 53 through either brush 55 or brush 56 depending upon which brush is in electrical contact with a commutator segment 53. From commutator segment 53, the electrical power flows into either the control coil filament group 27-b or the control coil filament group 27-a through one of the common connections 25 or 24-a, respectively. Electrical power flows back to the power supply in the direction 31 out of either the control coil filament group 27-b or 27-a through their respective common connections 24 or 25-a.

FIG. 14 shows a brush and slip ring commutator further wired to provide pulse width modulation (PWM) capability for controlling current and motor speed. The circuit for transferring power through electro-mechanical device is similar but further includes a power switch 40, controller 32, and sensors 33. The power switch 40 is added between brush 51 and the electrical power supply to switch the power supply ‘on’ and ‘off’. This switching creates pulses which can be used to control how much power is in the control coils. The ‘on’ or ‘off’ state of power switch 40 is determined by controller 32 and its associated sensors 33. The controller 32 adjusts the PWM signal based on information from the sensors 33. The sensors 33 can be Hall Effect sensors, optical or circuit components such as op amp comparators and the like to supply control signals to controller 32. The controller can be comprised of discrete electronic components and/or a micro-controller or microprocessor.

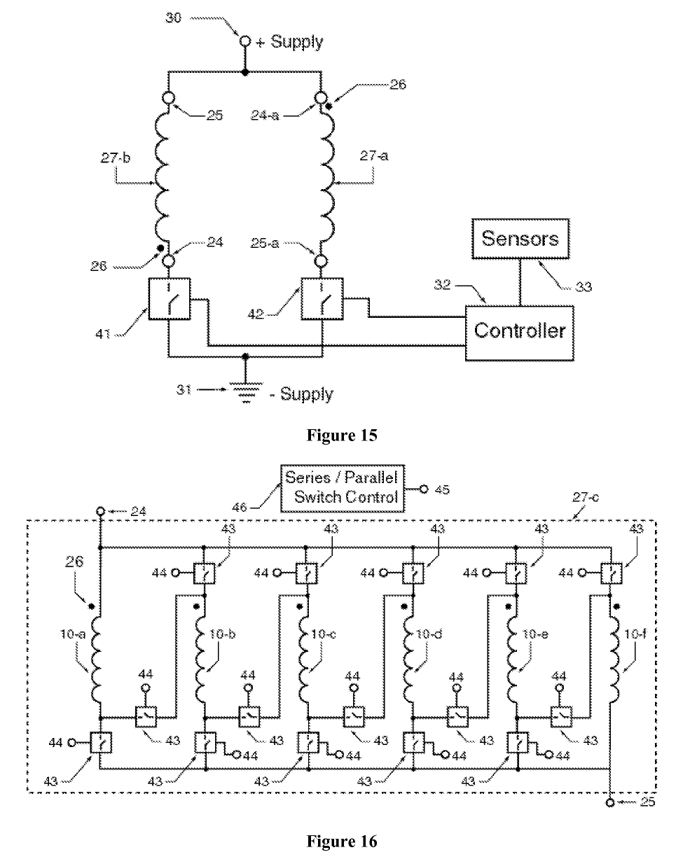

FIG. 15 shows an electronic switching method for determining through which of the two control coil filament groups 27-b or 27-a electrical power flows from an electrical power supply. Electrical power from a power supply flows through either the control coil filament group 27-b or the control coil filament group 27-a into either through one of the common connections 25 or 24-a. The control coil filament group 27-b common connection 24 is connected to power switches 41 and the control coil filament group 27-a common connection 25-a is connected to power switches 42. Which filament group the electrical power flows through is determined by which of the power switches 40 or 41 is ‘on’ or ‘off’ as determined by the controller 32. The controller 32 determines which switch will be ‘on’ or ‘off’ depending upon information received from sensors 33 for rotor position and current and voltage values. The sensors 33 can be Hall Effect sensors, optical or circuit components such as op amp comparators and the like to supply control signals to controller 32. The controller can be comprised of discrete electronic components and/or a micro-controller or microprocessor. The electrical power flows out of the ‘on’ electrical switch 40 or 41 back to the power supply negative 31. The power switches 40 and 41 can be IGBTs power MosFets or similar switches.

FIGS. 4A-4D and FIGS. 9-12 show the various series/parallel electrical wiring configurations that can be used for control coils of a bridge wound electro-mechanical device. FIG. 16 shows a circuit diagram that enables switching among the various configurations of control coil wiring. The advantage of this electronic configuration is that the control coils can be switched from one configuration to another while the electro-mechanical device is running in a motor or generator function to match a particular speed or load requirement. In FIG. 16, by turning on and off various combinations of the switches 43 connected to one of the filaments of the bifilar wound control coils (for example, 10-a1 or 10-a2), or to single filament control coils 10-a through 10-f, all of the previously described configurations for a filament group can be obtained. The electronically configured group 27-c forms one filament group of a bifilar wound control coil (27-a or 27-b) or one single filament control coil group 27 with electrical power common connections 24 and 25. Since current never reverses in a filament in a bifilar wound control coil, the power switches 43 can be IGBTs power MosFets or similar switches for a bifilar control coil electronic configuration switch. For single filament control coils where the current would reverse, the power switches 43 are bi-directional and can be implemented with a triode for alternating current (TRIAC) or ‘back to back’ IGBTs, power MosFets or similar switches.

Series/parallel switch control 46 is an electronic controller that sends control signals to each of the switches 43 through plurality of wires 45. One wire from plurality of wires 45 is coupled to each terminal 44 of a switch 43. For ease of illustration, these connections have not been made on FIG. 16. The control signal can be a voltage signal that when applied turns the switch 43 ‘on’. The series/parallel switch control 46 can be setup to switch multiple switches 43 at once to change among various wiring configurations during motor or generator functioning on the electromechanical device. The series/parallel switch controller 46 can be implemented with discrete electronic components and/or a micro-controller or microprocessor.

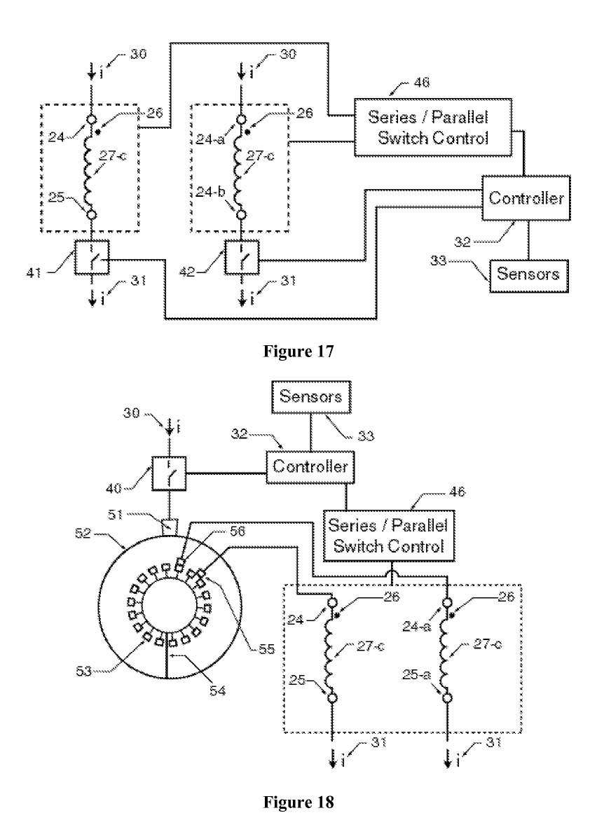

FIG. 17 shows an electronic switching method for use with electronically configured group 27-c and parallel/series switch controller 46. In FIG. 17 controller 32 can be coupled to series/parallel switch control 46 to switch among various parallel and series configurations of the control coils. The controller 32 can provide signals to indicate when to switch wiring configurations for the control coils from information obtained from sensors 33. Additionally, if controller 32 is implemented with a microprocessor, an algorithm can be used to determine what wiring configuration is most efficient for the current requirements of the electro-mechanical device.

FIG. 18 shows a brush and slip ring commutator further wired to provide pulse width modulation (PWM) capability and electronic control coil wiring switching with a series/parallel switch control 46. Controller 32 is coupled to switch 40 to provide PWM and coupled to series/parallel switch control 46 to electronically select a control coil configuration for use with bifilar wound control coils.

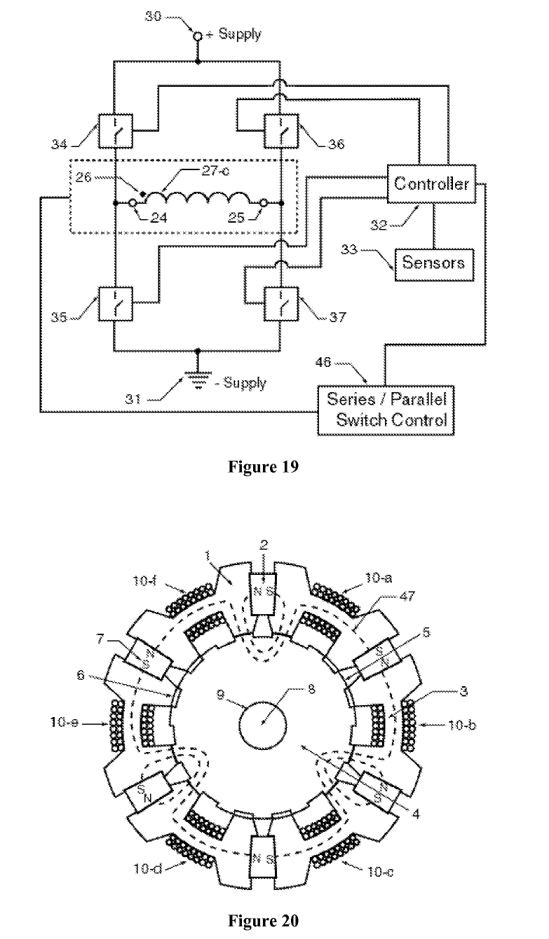

FIG. 19 shows an H bridge for alternating the direction of current flow through single filament bridge wound control coils that further provides electronic control coil wiring switching. The controller 32 is coupled to switches 34-37 to control power flow through filament group 27-c and to series/parallel switch control 46 to switch between control coil wiring configurations.

The principle of operation for the motor functionality of the bridge wound electro-mechanical device is that a control coil can be energized to create a polarity in the stator segment that interacts with a permanent magnet's magnetic flux and creates a torque on the rotor. The torque on the rotor comes from the magnetic flux interacting with poles on the rotor that are not in alignment. The magnetic flux pulls the rotor's poles into alignment. Once the poles are aligned, rotor movement is continued by flipping the polarity of the stator segment. This can be accomplished by changing the direction of the current in the control coils. In a single filament control coil embodiment, an H bridge can be used to switch the current and polarity across the control coils. In a bifilar control coil embodiment, the polarities are flipped by switching which control coil is energized.

FIG. 20 shows the permanent magnet flux 47 of the bridge wound electro-mechanical device with no electrical power applied to the control coils 10-a through 10-f. The control coils 10-a through 10-f can be either single filament or bifilar wound. In FIG. 20, the salient poles 5 of rotor 4 are aligned and the permanent magnet flux 47 passes onto rotor 4 across an air gap in some places.

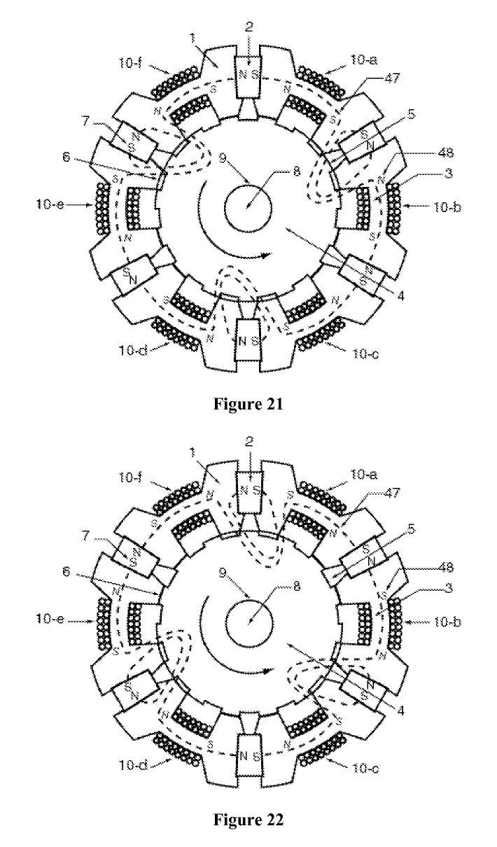

FIG. 21 shows the permanent magnet flux 47 with the control coils 10-a through 10-f energized to produce the magnetic polarities 48 shown. The permanent magnet flux acts across the air gap onto the rotor creating a torque to align the stator poles 6 and rotor poles 5 upon which the permanent magnetic flux is acting. Energizing the coils with a first polarity produces a magnetic flux that couples with the flux produced by permanent magnets 2 to redirect and place this coupled flux across unaligned rotor poles 5.

FIG. 22 shows the permanent magnet flux 47 with the control coils 10-a through 10-f energized using any of the methods described in the previous figures to produce the magnetic polarities 48 shown. The permanent magnet flux acts across the air gap between the rotor and stator creating a torque to align the now un-aligned stator poles 6 and rotor poles 5 across which the permanent magnetic flux is acting.

By alternately energizing the control coils 10-a through 10-f with opposite magnetic polarities as shown in FIGS. 21 and 22 a rotating torque is applied to the rotor resulting in the rotor producing rotating mechanical power at the shaft to do work outside the electro-mechanical device. If the rotor shaft is rotated by an external prime mover the electro-mechanical device becomes a generator. The permanent magnet flux 47 shown in FIG. 20 induces a potential in the control coils 10-a through 10-f due to the changing the air gap reluctance as the rotor poles 5 and stator poles 6 move in and out of alignment.

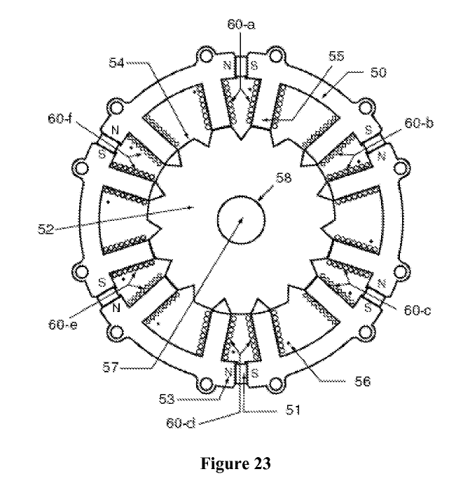

FIG. 23 shows a single phase pole wound electro-mechanical device that includes six stator segments 50, six permanent magnets 51, a rotor 52 and six control coils 60-a through 60-f. The rotor is mounted on a shaft 58 to rotate about a central axis of rotation 57 and has fifteen salient rotor poles 54. Each stator segment 50 has two salient stator poles 55, and each salient stator pole 55 is wound by one control coil of control coils 60-a through 60-f. This embodiment contains twelve control coils arranged in pairs of two control coils for six control coil groups 60-a through 60-f. In operation, every other group of control coil groups 60-a through 60-f is energized at any given time. For example, control coil groups 60-a and 60-c and 60-e are energized at the same time and the control coil groups 60-b and 60-d and 60-f are energized at the same time. Of two control coils forming a pair one of the control coils is wound on the pole 55 of one stator segment 50 and the second control coil is wound on the pole 55 of an adjacent stator segment 50 on opposite poles of a permanent magnet 51. The six permanent magnets 51 are placed between each stator segment poles 55 with their magnetic fields opposing. That is, on either side of a stator segment 1, the same magnetic faces (north or south) of the permanent magnets 51 are adjacent to one another.

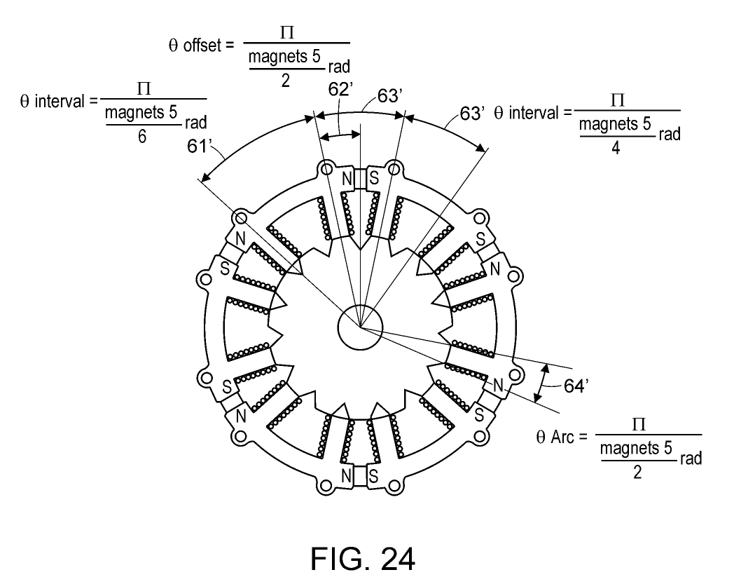

FIG. 24 shows one possible angular relationships and equations 61′, 62′, 63′ for the stator poles and a rotor pole arc 64′ for the pole wound electro-mechanical device. The angular interval between stator poles comprising one pole pair (angle 61′ of FIG. 24) is a derivative of the number of magnets placed in the stator and is given in radians by:

$${θ}_{interval} = \frac{π}{( \frac{magnets \cdot 5}{6} )}$$

And the angular intervals by which the pole pairs are separated (angle 63′ of FIG. 24) are also a derivative of the number of magnets in the stator and are given in radians by:

$${θ}_{interval} = \frac{π}{( \frac{magnets \cdot 5}{4} )}$$

The rotor pole arc, rotor reluctance gap arc, a stator pole arc, and the angular offset of a stator pole in a pole pair from a line originating at the rotor's central axis of rotation and intersecting the center of one of the permanent magnets (angle 62′ and 64′ of FIG. 24) are all equal and are also a derivative of the number of magnets in the stator and are given in radians by:

$$θ = \frac{π}{( \frac{magnets \cdot 5}{2} )}$$

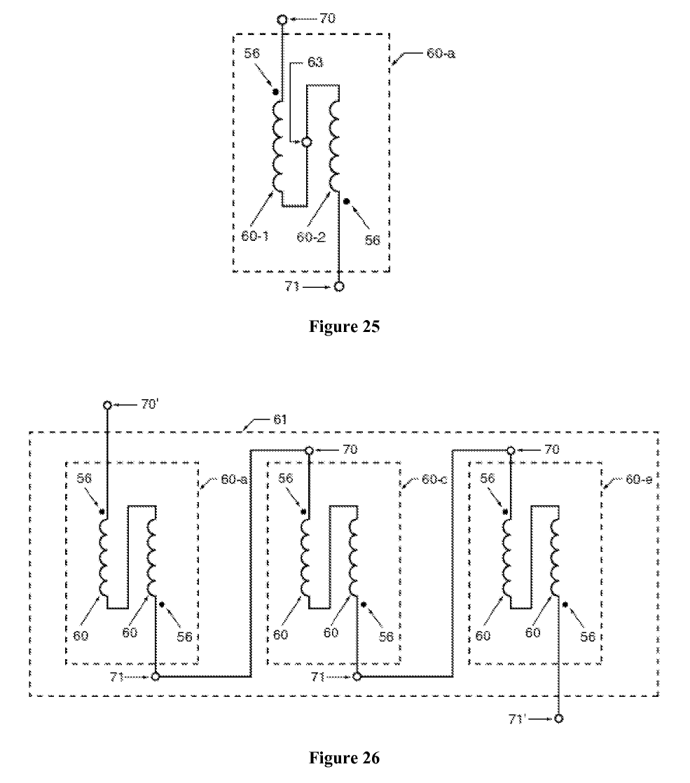

FIGS. 25 through 27 shows various control coil configurations for use in the pole wound electro-mechanical device. FIG. 25 shows the electrical wiring diagram for one of the control coil pairs 60-a shown in FIG. 23. A control coil pair 60-a consists of two control coils 60-1 and 60-2 connected in series with non-start connections 63 coupled together. The start connections 56 of the two series connected control coils 60-1 and 60-2 form common electrical connections 70 and 71 to the control coil pair 60-a.

FIG. 26 shows the wiring diagram for the first control coil group 61 of the three control coil pairs 60-a, 60-c and 60-e that are energized at the same time for the pole wound electro-mechanical device embodiment shown in FIG. 23. In the control coil group 61, control coils 60-a, 60-c and 60-e are electrically connected in series at connections 70 and 71. Control coil group 61 has two common electrical connections 70′ and 71′ for applying electrical power. The coil pairs and the pairs within a control coil group may be electrically wired in parallel or series parallel combinations as was discussed above for another embodiment. Further, switches can be used among control coils 60 to switch the control coils 60 between various series, series parallel, and parallel arrangements.

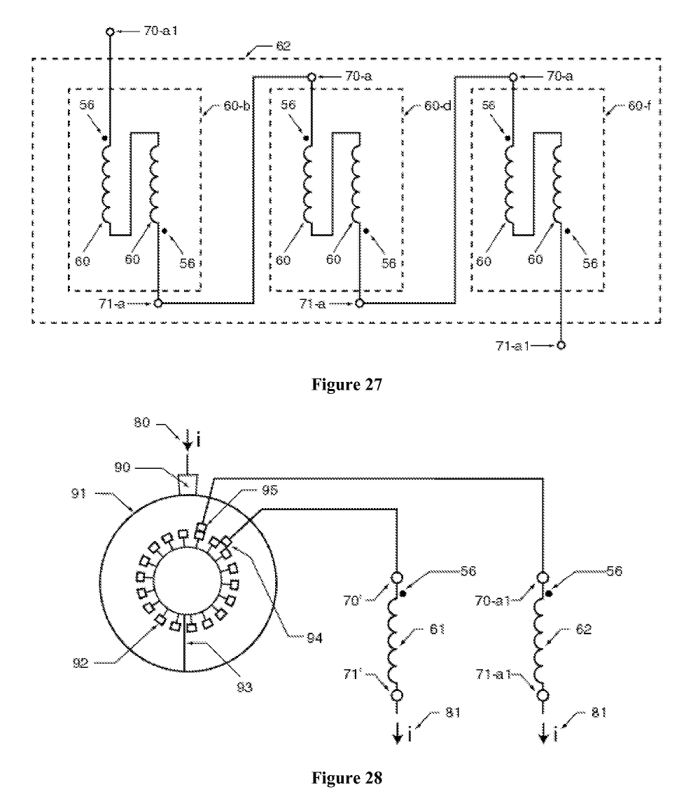

FIG. 27 shows the wiring diagram for the first control coil group 62 of the three control coil pairs 60-b, 60-d and 60-f that are energized at the same time for the pole wound electro-mechanical device embodiment shown in FIG. 23. In the control coil group 62, control coils 60-b, 60-d and 60-f are electrically connected in series at connections 70-a and 71-a. Electrical power is applied to control coil group 61 at common electrical connections 70-a1 and 71-a1. The coil pairs and the pairs within a group could also be electrically wired in parallel or series parallel combinations as discussed above.

FIG. 28 shows a brush and slip ring commutator for determining through which of the two control coil groups electrical power will flow from an electrical power supply for the pole wound electro-mechanical device. The control coil groups can be electrically wired in one of the configurations described in FIGS. 25-27 or in various parallel or series parallel combinations. Electrical power from a power supply flows into brush 90 in direction 80. The brush 90 transfers this electrical power into slip ring 91 which transfers this electrical power 93 to a segmented commutator 92. The electrical power is then transferred from the segmented commutator through either brush 94 or brush 95 depending upon which brush is in electrical contact with commutator segment 92. The electrical power then flows into control coil group 61 or control coil group 62 through one the control coil groups common start connections 70′ or 70-a1. Electrical power flows back to the power supply in direction 81 out of either the first 61 or second 62 control coil group through their respective common connections 71′ or 71-a1.

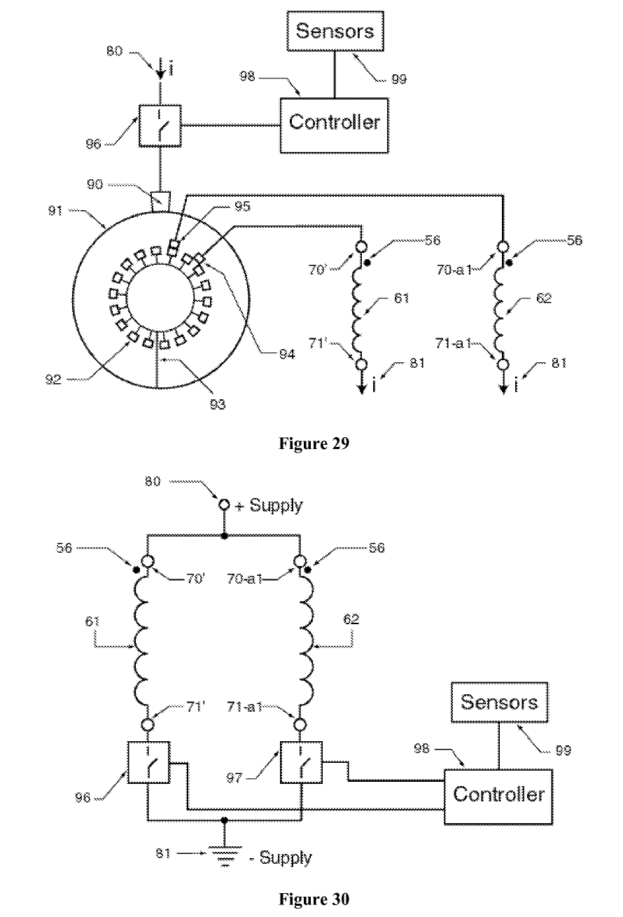

FIG. 29 shows an a brush and slip ring commutator for determining through which of the two control coil groups electrical power will flow from an electrical power supply for the pole wound electro-mechanical device. The operation is the same as described in FIG. 28 except a power switch 96 is added between brush 90 and the electrical power supply to add pulse width modulation (PWM) capability for controlling current and motor speed. The ‘on’ or ‘off’ state of power switch 96 is determined by controller 98 and its associated sensors 99. The controller 98 adjusts the PWM signal based on information from the sensors 99. The sensors 99 can be Hall Effect sensors, optical sensors, or circuit components such as op amp comparators and the like to supply control signals to controller 98. The controller can be comprised of discrete electronic components and/or a micro-controller or microprocessor. The power switch 96 can be IGBTs power MosFets or a similar switch.

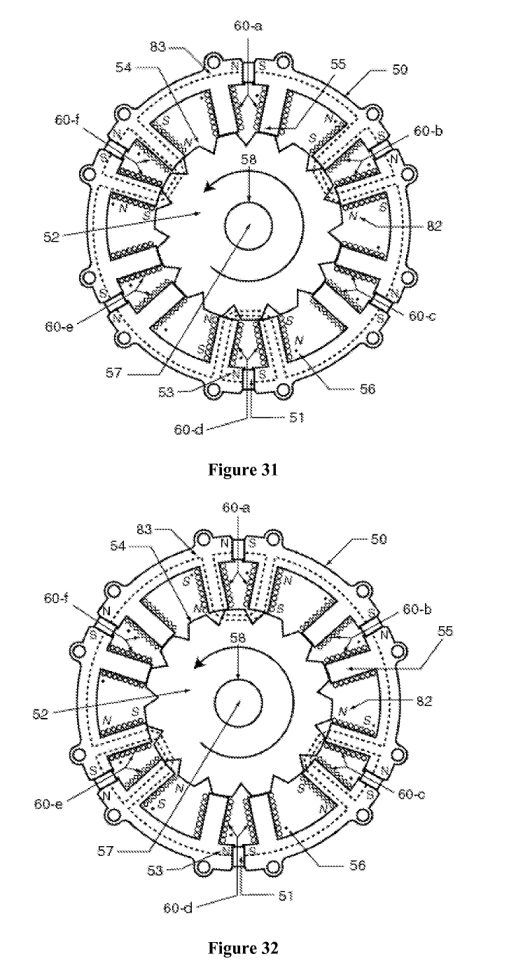

FIG. 30 shows an electronic switching method for determining through which of the two control coil groups electrical power will flow from an electrical power supply for the pole wound electro-mechanical device. Electrical power from a power supply flows through either control coil group 61 or 62 through the one control coil group's common connections 70′ or 70-a1. The control coil groups common connections 71′ and 71-a1 are connected to power switches 96 and 97 respectively. Which control coil group 61 or 62 the electrical power flows through is determined by which of the power switches 96 or 97 is ‘on’ or ‘off’ as determined by the controller 98. The controller 98 determines which switch will be ‘on’ or ‘off’ depending upon information received from sensors 99 for rotor position and current and voltage values. The sensors 99 can be Hall Effect sensors, optical components or circuit components such as op amp comparators and the like to supply control signals to controller 98. The controller can be comprised of discrete electronic components and/or a micro-controller or microprocessor. The electrical power flows out of the ‘on’ electrical switch 96 or 97 back to the power supply. The power switches 96 and 97 can be IGBTs power MosFets or similar switches.

The principle of operation for the pole wound electro-mechanical device is similar to that of the bridge wound electro-mechanical device. A control coil can be energized to create a polarity in the stator segment that interacts with a permanent magnet's magnetic flux and creates a torque on the rotor. The torque on the rotor comes from the magnetic flux interacting with poles on the rotor that are not in alignment. The magnetic flux pulls the rotor's poles into alignment. FIG. 31 shows the permanent magnet flux 83 with the control coil groups 60-b, 60-d and 60-f energized to produce the magnetic polarities 82 shown. The permanent magnet flux 83 acts across the air gap between the rotor and stator creating a torque to align the stator poles 55 and rotor poles 54 across which the permanent magnetic flux 83 is acting.

Once the rotor poles 54 are aligned with the stator poles 55 that are energized (corresponding to control coil groups 60-b, 60-d and 60-f), rotor movement is continued by energizing a next set of control coils which are not in alignment. FIG. 32 shows the permanent magnet flux 83 with the control coil groups 60-a, 60-c and 60-e energized to produce the magnetic polarities 82 shown. Control coil groups 60-a, 60-c and 60-e are not in alignment when initially energized, so energizing these control coil groups pulls the rotor poles in the same direction into alignment. By alternately energizing the control coils with opposite magnetic polarities as shown in FIGS. 31 and 32, a rotating torque is applied to the rotor 52 resulting in the rotor producing rotating mechanical power at the shaft 58 to do work outside the electro-mechanical device. If the rotor shaft is rotated by an external prime mover such as a simple external torque, the electro-mechanical device functions as a generator. The permanent magnet flux 83 induces a potential in the control coil groups 60-a through 60-f as the rotor 52 is spun because the air gap reluctance changes as the rotor poles 54 and stator poles 55 move in and out of alignment.

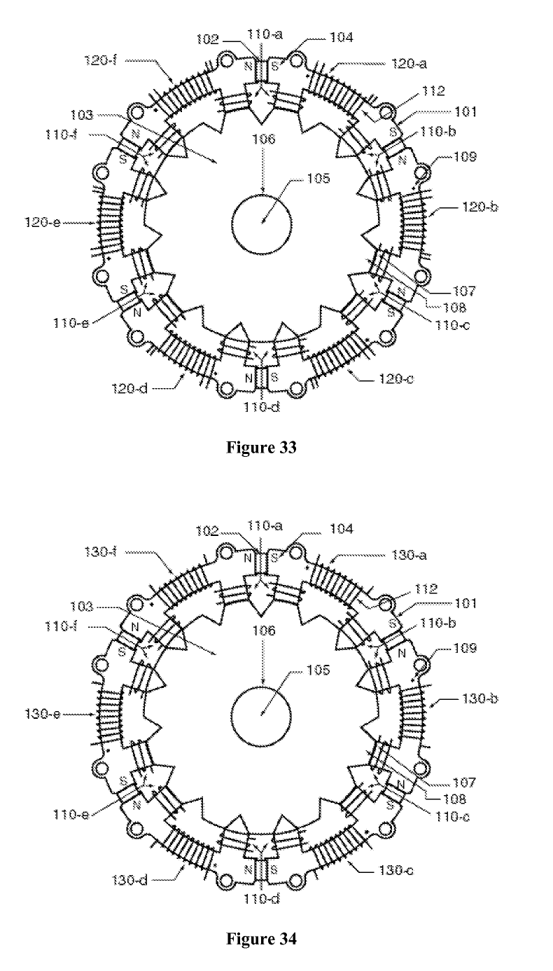

FIGS. 33 and 34 combine the functionality of the control coils being wound on both the bridge 112 and poles 107 of a stator segment 101. FIG. 33 illustrates bifilar wound control coils wound on the bridges 112 of the stator segments 101, and FIG. 34 illustrates single filament control coils wound on the bridges 116 of a stator segment 101. The difference between the motor embodiments of FIGS. 33 and 34 is the bridge control coils in the embodiment of FIG. 34 uses single filament windings and the embodiment of FIG. 33 uses bifilar wound bridge control coils. Four switches are used to reverse the current in the single filament control coils and two switches are used to reverse the current in the bifilar control coils, otherwise the principle of operation for the embodiments shown in FIGS. 33 and 34 are the same.

FIG. 33 shows a single phase electro-mechanical device using bifilar control coils wound on the bridge 112 of a stator segment 101 and single filament control coils wound on the stator poles 107. This embodiment of the electro-mechanical device includes six stator segments 101, six permanent magnets 102, a rotor 103 and six bifilar control coils 120-a through 120-f and six single filament control coil pairs 110-a through 110-f. The rotor 103 is mounted on a shaft 106 to rotate about a central axis of rotation 105 and has fifteen salient rotor poles 108. Each stator segment 101 has two salient stator poles 107 with single filament control coil pairs 110-a through 110-f wound on the salient stator poles 107 and six bifilar control coils 120-a through 120-f wound on a stator segment bridges 112. The six permanent magnets 102 are placed between each stator segment 101 with the magnetic fields opposing. That is, on either side of a stator segment 101, the same magnetic faces (north or south) of the permanent magnets 102 are adjacent to one another.

FIG. 34 shows a single phase electro-mechanical device using single filament control coils wound on the bridge 112 of a stator segment 101 and single filament control coils wound on the stator poles 112. This embodiment of the electro-mechanical device includes six stator segments 101, six permanent magnets 102, a rotor 103 and six control coils 130-a through 130-f and six control coil pairs 110-a through 110-f. The rotor is shaft 106 mounted to rotate about a central axis of rotation 105 and has fifteen salient rotor poles 108. Each stator segment 101 has two salient stator poles 107 with control coil pairs 110-a through 110-f wound on the salient stator poles 107 and six control coils 130-a through 130-f wound on a stator segment bridges 112. The six permanent magnets 102 are placed between each stator segment 101 with the magnetic fields opposing.

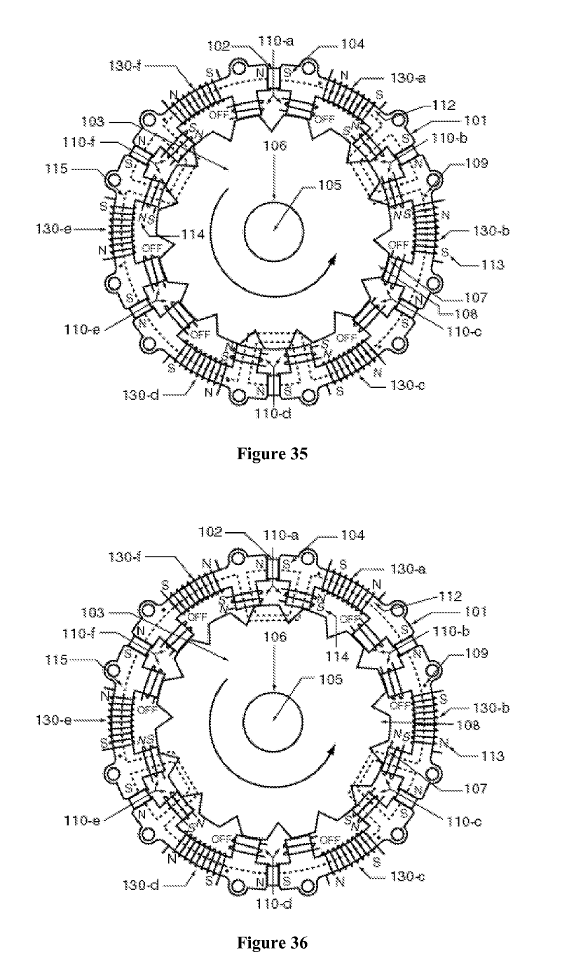

The principle of operation for the motor functionality of the bridge and pole wound electro-mechanical device involves energizing both the bridge wound control coil as well as the pole wound control coil. FIG. 35 shows the permanent magnet flux 109 with the control coil pairs 110-a through 110-f energized and the control coils 120-a through 120-f energized to produce the magnetic polarities 104 and 114 as shown. As one skilled in the art would understand, any of the methods described above can be used to produce the magnetic polarities. Energizing the first bridge and pole wound control coils redirects and places magnetic flux from the permanent magnets and the control coils across a first air gap between a first set of unaligned rotor and stator poles and through a section of the rotor. The flux then crosses back across a second air gap through a second set of unaligned rotor and stator poles. This redirected magnetic flux acts to produce a torque to bring the unaligned stator poles 107 and rotor poles 108 into alignment. The flux of the permanent magnets 102 and the bridge and pole wound control coils can be continually redirected by controlling the magnetic polarity of the control coils. By changing the polarity of control coils as the rotor and stator poles move into alignment, the magnetic flux is redirected to a next set of rotor and stator poles (FIG. 36) that are unaligned creating a rotating torque on the rotor.

FIG. 36 shows a change in the magnetic polarities 104 and 114 of the control coil pairs 110-a through 110-f and the control coils 130-a through 130-f. This change in the magnetic polarities can be caused by changing the direction of the current in the control coils. The change in the polarities acts to create further rotational torque. The magnetic flux acts across the air gap between the rotor and stator creating a torque to align the now unaligned stator poles 107 and rotor poles 108 across which the permanent magnetic flux is acting. By alternately energizing the control coils with opposite magnetic polarities as shown in FIGS. 35 and 36 a rotating torque is imparted to the rotor 103 resulting in the rotor 103 producing rotating mechanical power at the shaft 106 to do work outside the electro-mechanical device.

If the rotor shaft is rotated by an external prime mover the bridge and pole wound electro-mechanical device functions as a generator. The permanent magnet flux 109 shown in FIGS. 33 and 34 induces a potential in the control coil pairs 110-a through 110-f and control coils 120-a through 120-f or 130-a through 130-f due to the changing the air gap reluctance as the rotor poles 108 and stator poles 107 move in and out of alignment.

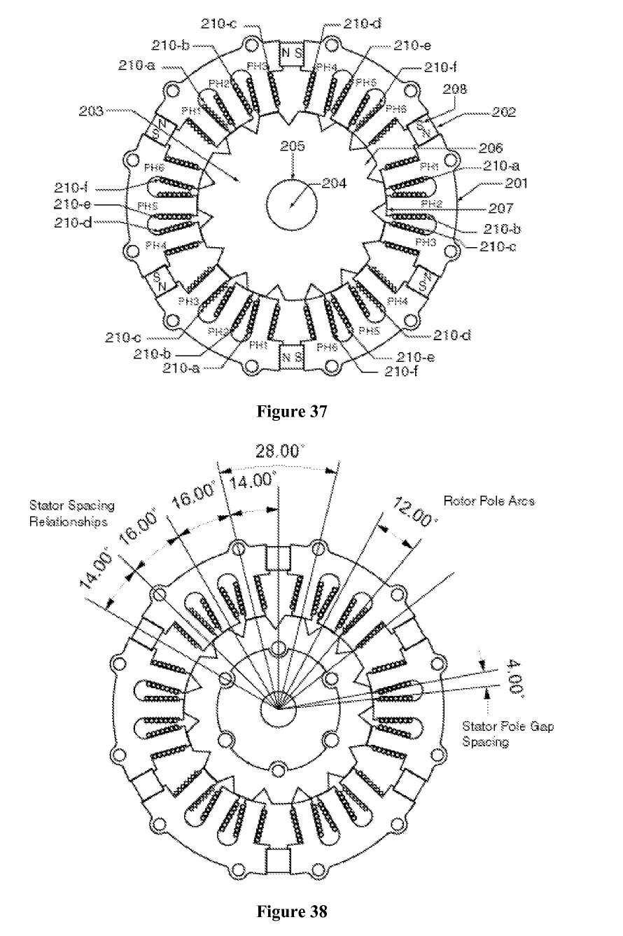

FIG. 37 shows a multiphase electro-mechanical device including six stator segments 201, six permanent magnets 202, a rotor 203 and three groups of six control coils 210-a through 210-f. The rotor 203 is mounted on a shaft 205 rotate about a central axis of rotation 204 and has fifteen salient rotor poles 206. Each stator segment 201 has three salient stator poles 207 with control coils wound on the salient stator poles 207. Each group of three groups of six control coils 210-a and 210-f form six motor phases. Where control coils 210-a form phase one, control coils 210-b form phase 2, control coils 210-c form phase 3, control coils 210-d form phase 4, control coils 210-e form phase 5 and control coils 210-f form phase 6. The six permanent magnets 202 are placed between each stator segment 201 with their magnetic fields opposing. That is, on either side of a stator segment 101, the same magnetic faces (north or south) of the permanent magnets 102 are adjacent to one another.

FIG. 38 shows one possible angular relationship for the stator poles and a rotor pole arc for the multiphase electro-mechanical device. Other angular relationships can be used, and the spacing relationships can be scaled as a function of the number of permanent magnets used. As shown, a first stator pole can be placed 14 deg off the permanent magnet when sweeping from centerline to centerline using the rotor shaft as the origin. The next stator pole can be 16 deg off the first stator pole. The spacing between adjacent stator poles on either side of a permanent magnet can be 28 deg. The rotor pole arcs can be spaced at 12 deg and the stator pole gap spacing can be at 4 deg.

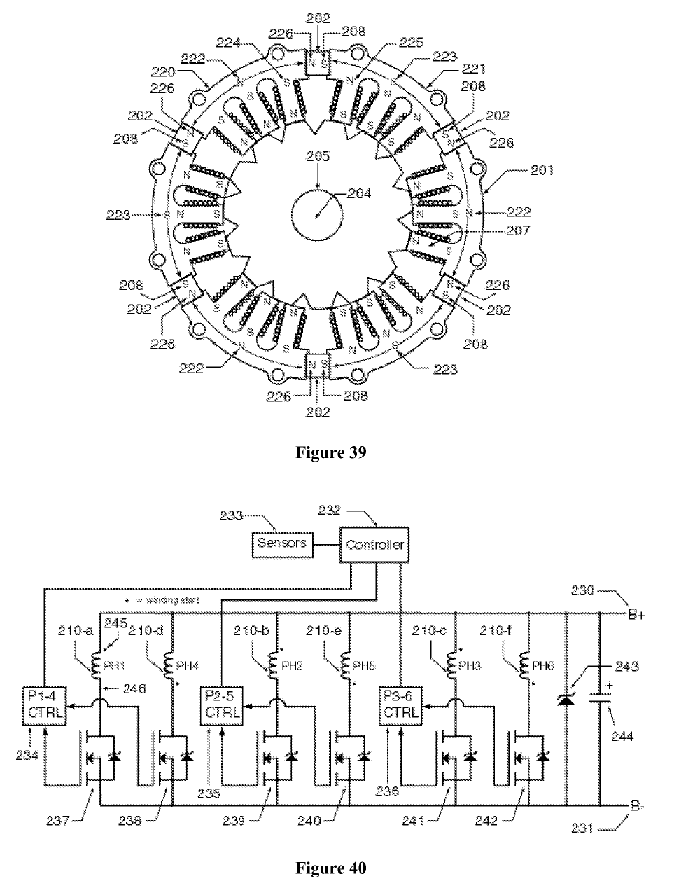

FIG. 39 shows the polarities of control coils 210-a through 210-f in one embodiment of the multiphase electro-mechanical device. In this embodiment, the control coils are either energized with the current flowing in one direction or the control coils not energized with current. In some embodiments, the current may be reversed momentarily to quickly dissipate the energy stored in a control coil. This reduces the control coil's transition time from being energized to being ‘off’. The polarity 226 or 208 of the permanent magnets 202 adjacent to a stator segment 201 indicate how the windings on the salient poles 207 of each stator segment 201 are energized. A stator segment 201 adjacent two permanent magnets' north poles 226 would be considered a North Pole stator segment 222, and the control coils wound on the salient poles 207 of a North Pole stator segment 222 are energized to produce the magnetic polarities 224. A stator segment 201 adjacent two permanent magnets' south poles 208 would be considered a South Pole stator segment 223 and the control coils wound on the salient poles 207 of a South Pole stator segment 223 would be energized to produce the magnetic polarities 225.

FIG. 40 shows one mechanism for switching control coils ‘on’ or ‘off’ during motor function operation. As shown, the non-start terminal 246 of the control coils forming phase one 210-a are connected to switch 237, the non-start terminal 246 of the control coils forming phase two 210-b are connected to switch 239, the non-start terminal 246 of the control coils forming phase three 210-c are connected to switch 241. The start terminal 245 of the control coils forming phase four 210-d are connected to switch 238, the start terminal 245 of the control coils forming phase five 210-e are connected to switch 240 and the start terminal 245 of the control coils forming phase six 210-f are connected to switch 242. The other terminal of each of the control coils 210-a through 210-f that is not connected to a switch is connected to the electrical power supply positive 230. The connection of each of the switches 237 through 242 not connected to a control coil is connected to the electrical power supply ground 231.

The switches 237 and 238 controlling phase one and phase four are controlled by phase control 234, the switches 239 and 240 controlling phase two and phase five are controlled by phase control 235 and the switches 241 and 242 controlling phase three and phase six are controlled by phase control 236. Phase controls 234, 235 and 236 are connected to controller 232. The controller 232 indicates to the phase controls 234, 235, and 236 the switching to occur for operation of the electro-mechanical device. The phase controls 234, 235, and 236 can send a control signal, such as a voltage signal, to the switches which turns the switches ‘on’ and ‘off’. The controller 232 determines which switch will be ‘on’ or ‘off’ depending upon information received from sensors 233 for rotor position and current and voltage values. The sensors 232 can be Hall Effect sensors, optical sensor, or circuit components such as op amp comparators and the like to supply control signals to controller 232. The controller can be comprised of discrete electronic components and/or a micro-controller or microprocessor. The power switches 237 through 242 can be IGBTs power, MosFets, or similar switches.

In motor operation, the control coils are energized in a wave-like sequence around the stator segments. This energizing sequence stays ahead of a number of rotor poles and pulls the rotor poles along the energizing sequence. For example, referring to FIG. 37, control coil 210-a (PH1) may be first energized, then control coil 210-b (PH2) is energized, followed by control coil 210-c (PH3) energizing. As control coil 210-d energizes, control coil 210-a de-energizes. The energizing and de-energizing sequence is based on rotor poles coming into and out of alignment with the stator poles. The sequence is timed to pull a rotor pole into alignment with the stator pole and then turn off so that the magnetic flux does not create a breaking effect or cogging on the rotor's movement.

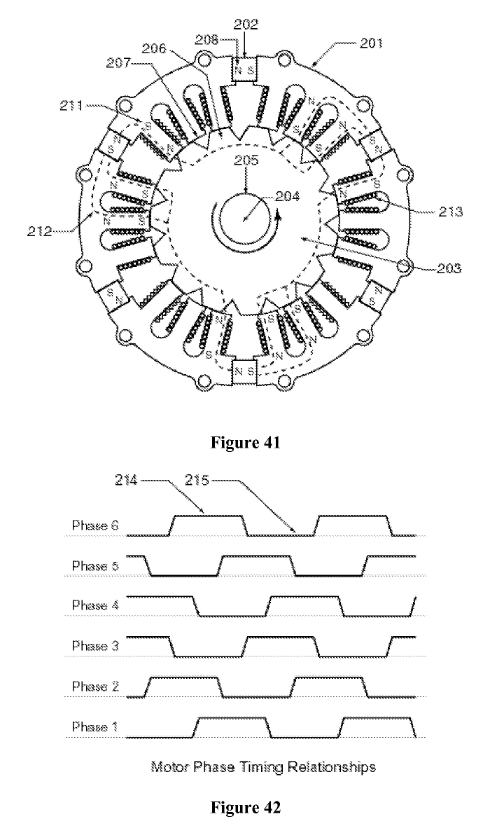

FIG. 41 shows the motor operation of the multiphase electro-mechanical device. As a rotor pole 206 begins to overlap in an aligning direction with a stator pole 207, the control coil on that stator pole is energized with a magnetic polarity 211 (see, e.g., FIG. 39 for the energized polarities). As any rotor pole 206 moves out of full alignment with a stator pole 207 the control coil on that stator pole is turned off. By sequentially turning energizing and turning off the control coils using the above described conditions for energizing and turning ‘off’ control coils a rotating torque is imparted to the rotor 203 resulting in the rotor 203 producing rotating mechanical power at the shaft 205 to do work outside the electro-mechanical device.

FIG. 42 shows a timing diagram for each of the control coils forming a phase for one embodiment of the multi-phase electro-mechanical device. The timing diagram can be viewed in conjunction with FIG. 37 where PH1 represents phase 1, PH2 represents phase 2, and so on to phase 6 (PH6). In the timing diagram of FIG. 42, 214 represents energized control coils forming a phase, and 215 represents ‘off’ control coils forming a phase. As shown in FIG. 41, a number of adjacent control coils can be energized at the same time due to overlap in the timing diagram of FIG. 42. As one skilled in the art would appreciate other timing sequences can be used with the multi-phase electro-mechanical device. The multi-phase electro-mechanical device can be operated with a three phase alternating current (AC) power supply in one embodiment. The electro-mechanical device functioning as a generator can produce AC three phase power without additional circuitry or conversion needed in another embodiment. For example, with the multi-phase electro-mechanical device the leads from the different phases would be coupled to three wires, each being one phase to operate with AC power as described above.

The multi-phase electromechanical device can function as a generator when the rotor shaft is rotated by an external prime mover. The permanent magnet flux 212 shown in FIG. 41 induces a potential in the control coils 210-a through 210-f due to the changing the air gap reluctance as the rotor poles 206 and stator poles 207 move in and out of alignment.

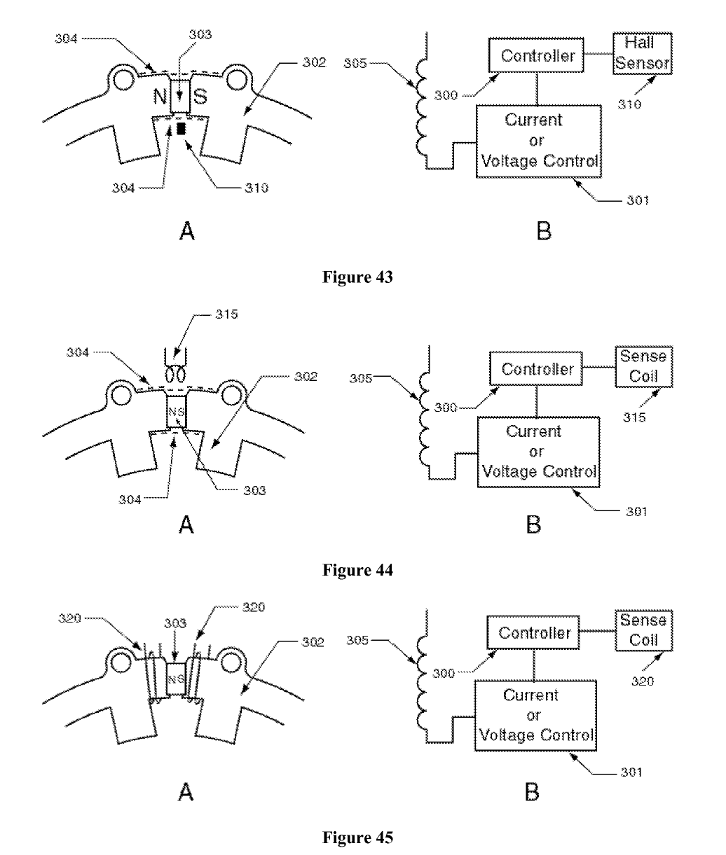

Motor/generators that have permanent magnets in their stator can utilize the permanent magnet's major and minor hysteresis loops to gain information about the operation of the motor/generator. These major and minor hysteresis loops result from the changes in the permanent magnet's flux density, which are prompted by variations in the reluctance of the air gaps across which the permanent magnet's flux acts. By sensing the changes in the permanent magnet's flux density, the electro-mechanical device's rotor position can be derived. The sensing circuit can be implemented using discrete op amp comparators, and can be further refined with the addition of a microprocessor or micro-controller for processing the level of the signal. FIGS. 43 through 46 show several methods and mechanisms for sensing the change in the permanent magnet's flux density. These methods can be applied to any electro-mechanical device such as a motor or generator using permanent magnets that produce a varying reluctance in the air gap between the rotor and stator poles.

FIG. 43-A shows a hall sensor embodiment for detecting changes in the permanent magnet's flux density. Hall sensor 310 is placed along a line 304 adjacent a permanent magnet 303, where the permanent magnet 303 is between two stator segments 302. In this position, the hall sensor can sense changes in the fringing flux produced by the permanent magnet 303 as the reluctance in the air gap varies between the rotor and stator poles.

FIG. 43-B shows a corresponding circuit setup for hall sensor 310 of FIG. 43-A. Hall sensor 310 is coupled to a controller for processing the signal from the hall sensor 310. The signal from the hall sensor can be an analog signal or a digital signal that provides the change information as well as the magnitude of the change. The controller 300 can be comprised of op amp comparators and/or a microprocessor or micro-controller and other discrete electronic components. The controller 300 can use the information included in the signal from the hall sensor 310 to control operation of the electro-mechanical device. For example, the information from the hall sensor 310 can indicate timing for energizing and de-energizing a control coil 305 and can provide information that can be used to control the amount of current in control coil 305 using pulse width modulation (PWM) or similar current control 301. The controller 300 can use this information to control switches that energize coils or provide PWM.

FIG. 44-A shows a sensing coil embodiment for detecting changes in the permanent magnet's flux density. The sensing coil 315 is placed along a line 304 adjacent a permanent magnet 303, where the said permanent magnet 303 is between two stator segments 302. The sensing coil can detect changes in the fringing flux produced by the permanent magnet 303 as the reluctance in the air gap varies between the rotor and stator poles.

FIG. 44-B shows a corresponding circuit setup for the sensing coil 315 of FIG. 44-A. Sensing coil 315 is coupled to a controller for processing the signal from the sensing coil, which can include information on changes in the fringing flux and the magnitude of the change. The controller 300 can be comprised of op amp comparators and/or a microprocessor or micro-controller and other discrete electronic components. The controller 300 controls whether a control coil 305 is either on or off based upon the sensor signal and can also control the amount of current in a coil using a PWM or similar current control 301.

FIG. 45-A shows a sensing coil embodiment for detecting changes in the permanent magnet's flux density. The sensing coil(s) 320 are wound on one or both of the stator segments 302 just adjacent a permanent magnet 303, where the said permanent magnet 303 is between two stator segments 302. The sensing coil can detect changes in the fringing flux produced by the permanent magnet 303 as the reluctance in the air gap varies between the rotor and stator poles.

FIG. 45-B shows a corresponding circuit setup for the sensing coil(s) 320 of FIG. 45-A. The sensing coil(s) 320 are coupled to a controller for processing the signal from the sensing coil. The controller 300 can be comprised of op amp comparators and/or a microprocessor or micro-controller and other discrete electronic components. The controller 300 controls whether a control coil 305 is either on or off based upon the sensor signal and can also control the amount of current in a coil using a PWM or similar current control 301.

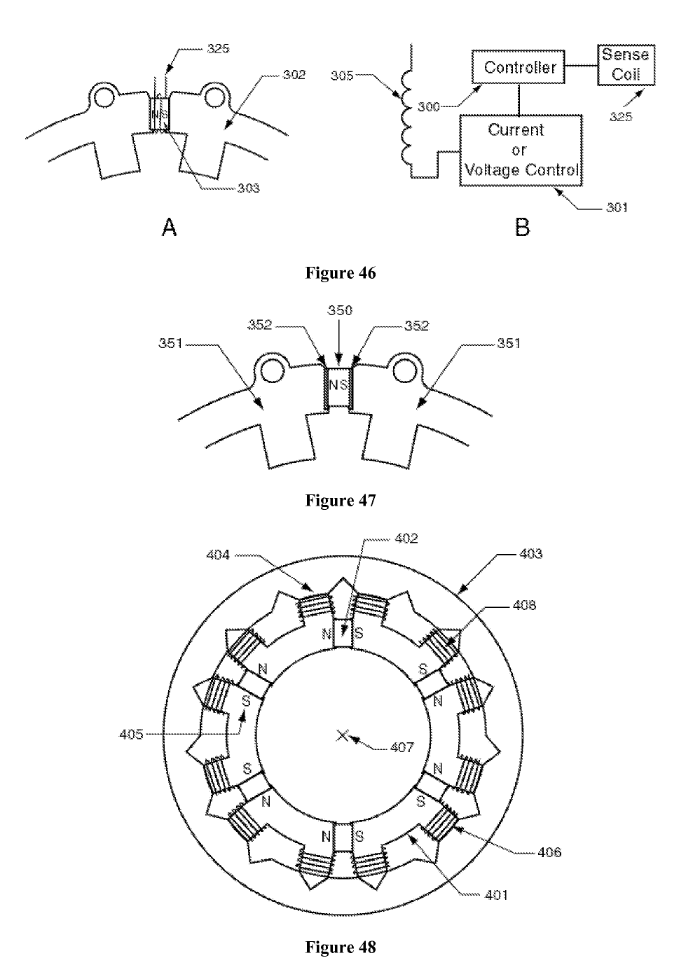

FIG. 46-A shows a sensing coil embodiment for detecting changes in the permanent magnet's flux density. The sensing coil 325 is wound on a permanent magnet 303 between the north and south poles, where the said permanent magnet 303 is between two stator segments 302. The sensing coil can detect changes in the fringing flux produced by the permanent magnet 303 as the reluctance in the air gap varies between the rotor and stator poles.

FIG. 46-B shows a corresponding circuit setup for the sensing coil 325 of FIG. 46-A. The sensing coil 325 is coupled to a controller for processing the signal from the sensing coil. The controller 300 can be comprised of op amp comparators and/or a microprocessor or micro-controller and other discrete electronic components. The controller 300 controls whether a control coil 305 is either on or off based upon the sensor signal and can also control the amount of current in a coil using a PWM or similar current control 301.

FIG. 47 shows an electrical and/or thermal insulating layer 352 which can be used in some embodiments. The insulating layer 352 is placed between the portions of the permanent magnet 350 that would otherwise touch the stator segments 351. This insulating layer 352 can provide benefits such as reducing eddy currents. The stator segments of the electro-mechanical device can be laminated to reduce eddy currents, but if the permanent magnet is nickel plated to prevent corrosion the nickel plating on the permanent magnet can short the laminated surfaces (lams) providing an electrical path for eddy currents to flow. Another problem that can arise is the reduction of the flux density of a permanent magnet. The flux density of permanent magnets typically reduces with increasing temperature and some permanent magnets are more temperature sensitive than others. The heat from power losses in the windings or copper losses can impact the performance of the permanent magnets. This heat is dissipated partly in the surrounding air, but to a greater extent into the stator and/or the rotor material. With motors that have both coils and the permanent magnets placed in the stator, it may be desirable to insulate the magnets from the heat produced by the copper losses. The electrical and/or thermal insulating layer 352 may be a physical wafer placed between the permanent magnets and their adjoining stator segments 351 or a coating placed on the permanent magnet 350 and/or the stator segments 351. This method could be applied to any motor using metal plated permanent magnets in a laminated rotor or stator or where control coils or phase coils have a thermal path to the permanent magnets. The electrical and/or thermal insulating layer 352 is a non-magnetic material in one embodiment.

FIG. 48 shows a ‘hub’ embodiment of the electro-mechanical device. This ‘hub’ embodiment is a construction where the rotor 403 rotates about the outside diameter of the stator segments 401. The ‘hub’ embodiment of the electro-mechanical device includes a rotor 403, stator segments 401, control coils 408, permanent magnets 402 and an axis of rotation 407 about which the rotor rotates. This ‘hub’ embodiment is sometimes desirable in traction applications, for example, where the motor's rotor can be integrated into a vehicle's wheel assembly. FIG. 48 is an example embodiment showing the rotor 403 placed on the outside diameter of the stator assembly, which one skilled in the art would recognize can be implemented using various techniques described in this application. For example, the ‘hub’ embodiment of FIG. 48 can be modified to include stator bridge windings or additional stator poles to operate as a multi-phase electro-mechanical device.

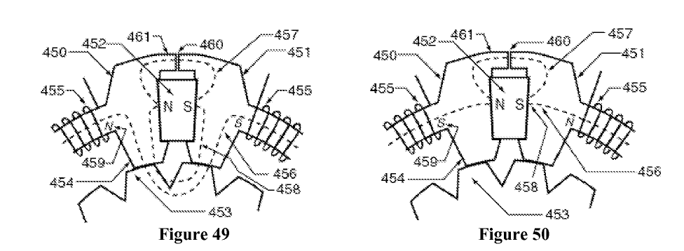

FIGS. 49 through 54 show field weakening/strengthening methods and mechanisms for controlling the amount of permanent magnet flux that acts in the air gap. The magnetic field of a permanent magnet is fixed with the exception of the permanent magnet's flux density changing as a result of the change in the reluctance of the air gap(s) across which the permanent magnet's flux acts. In some motor applications it is desirable to be able to vary the amount of permanent magnet flux that acts across the air gap between the rotor and stator poles, thus providing field weakening/strengthening capabilities.

FIG. 49 shows the addition of a reluctance bridge to the electro-mechanical device. The reluctance bridge 461 which includes a reluctance gap 460 partially surrounds a permanent magnet 452 placed between stator segments 450 and 451. In this example, the magnetic flux 456 of the control coils 455 are opposing the permanent magnets flux 457. The amount of permanent magnet flux 457 that traverses the reluctance gap 460 is proportional to the cross-section of the reluctance bridge 461 and the cross section of the stator poles 454 and the length of their respective air gaps. By adjusting the cross-section of the reluctance bridge 461 and the length of the reluctance gap 460, the amount of permanent magnet flux 458 available across the air gap between the rotor poles 453 and stator poles 454 is adjusted. The adjusted amount of magnetic flux available is magnetic flux 458 produced by the permanent magnet 452 minus the magnetic flux 457 that traverses the reluctance gap 460.

FIG. 50 shows the addition of a reluctance bridge to the electro-mechanical device where the magnetic flux 456 of the control coils 455 are coupling with the permanent magnet's flux 458. The amount of magnetic flux 457 that traverses the reluctance gap 460 is proportional to the cross-section of the reluctance bridge 461 and the length of its air gap 460 minus the permanent magnet flux 458 coupled with and redirected by the control coils 455 flux 456. When the magnetic flux 456 produced by the control coils 456 equals the magnetic flux produced by the permanent magnet 458 the reluctance gap 460 has virtually no effect.

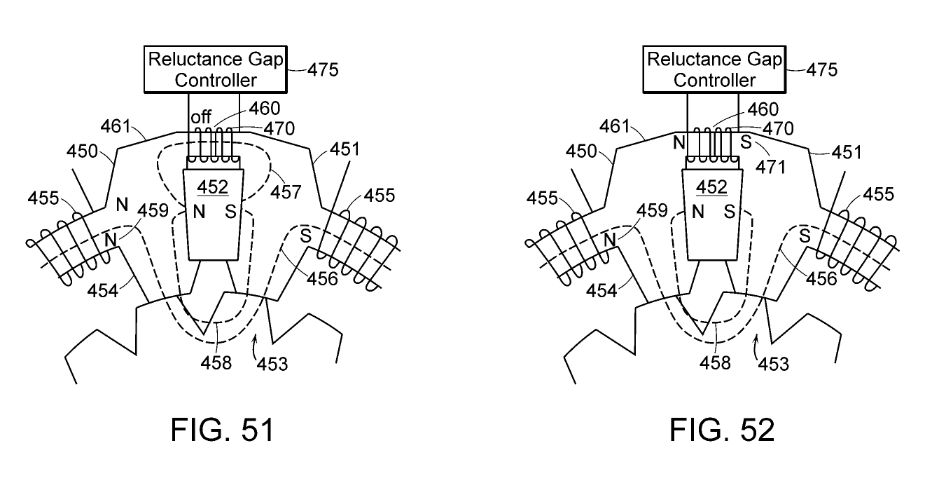

FIGS. 51 through 55 shows a reluctance gap controller and methods for controlling the magnetic flux acting upon the rotor of the electro-mechanical device. FIGS. 51 through 55 include a reluctance control coil 470 wound on the reluctance bridge 461 that is coupled to a reluctance gap controller 475. The reluctance gap controller 475 can be a microprocessor, a microcontroller, or a combination of dedicated circuit components. The reluctance gap controller can receive information regarding the magnetic flux from a sensing coil or a hall sensor (not shown) or can receive instructions or control signals from a controller (not shown). The reluctance gap controller 475 can energize the reluctance control coil 470 to adjust the magnetic flux acting upon the rotor. In FIGS. 51 through 55, the magnetic flux 456 of the control coils 455 are opposing the permanent magnets field 458. The amount of permanent magnet flux 457 that traverses the reluctance gap 460 is the same as described in FIG. 49, but is modified by the magnetic polarity 471 of and the field intensity of the reluctance bridge's control coil 470.

When the reluctance control coil 470 is off, in FIG. 51, the permanent magnet flux 457 through the reluctance gap 460 is the same as described in FIG. 49. The result of the reluctance control coil 470 being turned off is the same as if the reluctance bridge's control coil 470 did not exist. In FIG. 52, the reluctance control coil's 470 magnetic polarity 471 produces a magnetic flux that is equal to and of the same polarity as the permanent magnet's flux 458 that would traverse the reluctance gap 460 if the reluctance control coil 470 was off. By energizing the reluctance control coil 470 in this fashion, the magnetic polarity 471 places all of the permanent magnet's flux 458 across the rotor poles 453 and stator poles 454 air gap, but not does not add to the permanent magnet's flux 458.

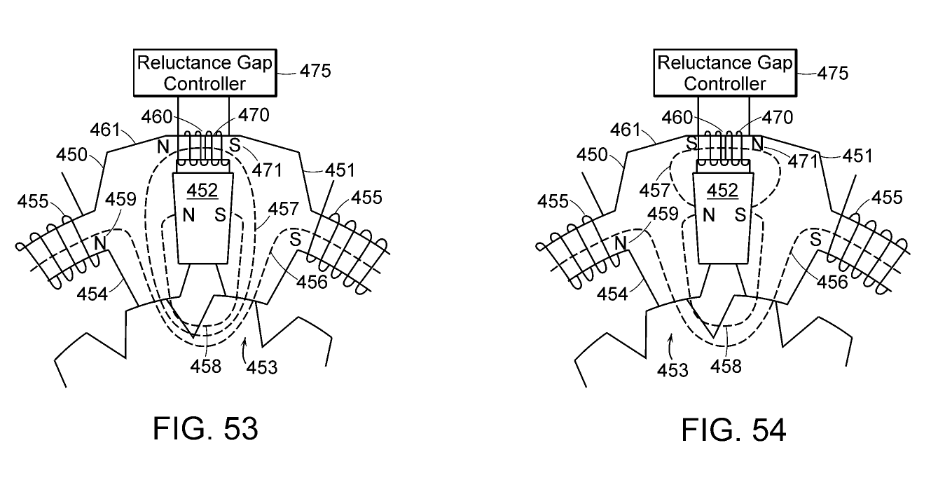

In FIG. 53 the reluctance control coil's magnetic polarity 471 produces a magnetic flux 457 that is greater and of the same polarity as the permanent magnet's flux 458 that would traverse the reluctance gap 460 if the reluctance control coil 470 was off. By energizing the reluctance control coil 470 in this fashion, the magnetic polarity 471 places the permanent magnet's flux 458 across the rotor poles 453 and stator poles 454 air gap, while adding any excess magnetic flux across the air gap to the rotor. Both FIGS. 52 and 53 show instances where the magnetic field is strengthened.

FIG. 54 shows where the reluctance control coil's 470 produces a magnetic polarity 471 that is opposite of the polarity of the permanent magnet's flux 458. In this case an opposite polarity in the reluctance control coil causes magnetic field weakening. The magnetic flux of the reluctance control coil 470 ‘couples’ with and removes a portion of the permanent magnet's flux 458 from the rotor poles 453 and stator poles 454 air gap. The amount removed is equal to the field intensity of the control coil 470 on the reluctance bridge 461.

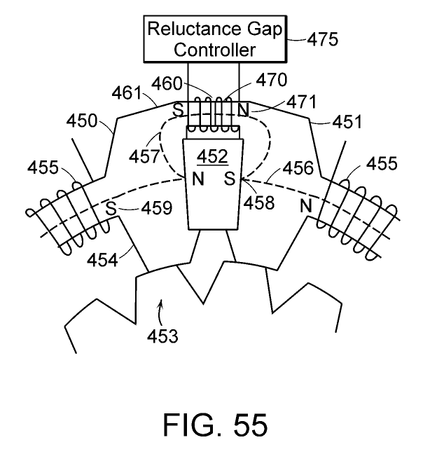

FIG. 55 shows where the reluctance control coil 470 produces a magnetic polarity 471 that is opposite of the polarity of the permanent magnet's flux 458. In FIG. 55 the reluctance control coil 470 is energized to reduce the permanent magnet's 452 magnetic flux 458 acting across the air gap to the rotor virtually to zero. When the magnetic flux 456 produced by the stator bridge control coils 455 equals the magnetic flux 458 produced by the permanent magnet 452, the reluctance gap 460 has virtually no effect. But when the magnetic flux 456 produced by the control coils 455 is less than that of the permanent magnet's flux 458, the reluctance control coil 470 can be energized to displace the permanent magnet's flux 457 not redirected by the control coil's coupling flux 456 into the reluctance bridge 461 thereby reducing the permanent magnet's flux in the rotor poles 453 and stator poles 454 air gap virtually to zero. Typically, the amount of magnetic flux 457 that traverses the reluctance air gap 460 is proportional to the cross-section of the reluctance bridge 461 and the length of the reluctance gap 460 minus the permanent magnet's flux 458 coupled with and redirected by the control coils 455 flux 456.

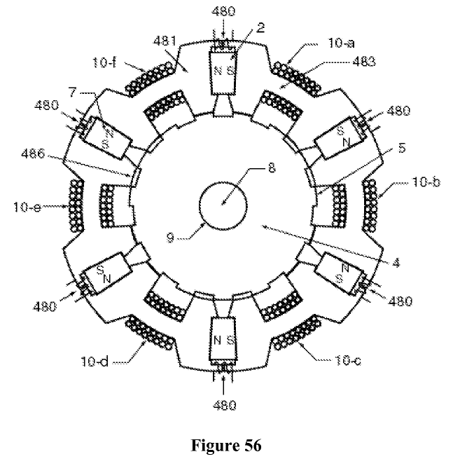

FIG. 56 shows an example of this field weakening/strengthening method applied to the bridge wound electro-mechanical device. The stator segments 481 include reluctance bridges with reluctance gaps and reluctance control coils 480 are wound on the reluctance bridges of the stator segments 481. This mechanism and method can be applied to any electro-mechanical device using permanent magnets that produce a varying reluctance in the air gap between the rotor and stator poles.

In some embodiments of the electro-mechanical device, the stator poles are grouped into pairs of poles. Then the pole pairs are separated from one another by a first angle and the poles in a pair are separated by a second angle. The pole pairs can then be optimized to produce the greatest possible pole arc and pole area with the least number of phase switching periods to rotate the rotor one revolution.

One problem with single phase motors is that the direction of rotation at startup is unpredictable. Single phase motors using optical or hall sensor encoders/interrupters to control the switching of the motor control coils or phases and with the sensor set to the optimal switching position can have an unpredictable start up rotational direction. To solve this problem an optical or hall sensor encoder could be permanently positioned in a slightly advanced or slightly retarded angular relationship to a rotor pole to reliably start the motor in one direction only. The problem with this method is that once the motor is running the control coils will always be switched at a less than an optimum relationship to the rotor and the direction of rotation would not be reversible. Adding two additional sensors, can solve the problem if one of the additional sensors is set to an angular point to one side of the optimal switching point and the other additional sensor is set to an angular point to the other side of the optimal switching point.

One start up and operating control method disclosed in one embodiment uses a rotor position sensor including an optical or hall sensor encoder/interrupter. The output of the rotor position sensor is coupled with an electronic circuit that measures the direction of the current flow through a control coil. The sensor is set to the optimal operating switching angle and during startup the startup rotation direction can be determined by the sensor output and the control coil current direction. If the rotor starts in the wrong direction the current in the control coil is pulsed in reversed, independent of the sensor output, with this process being repeated until the rotor is turning in the desired direction. Once the motor is running the current direction sensor output is turned off and the motor is operated only from the encoder sensor output being fed to a controller and power switches. The motor can be reversed by changing the desired parameters of sensor output level versus current direction.

A second start up and operating control solution disclosed in another embodiment uses a rotor position sensor comprised of a ratio metric linear hall effect sensor and at least one operational amplifier configured to operate as a comparator. The hall sensor is placed adjacent to the stator laminations in a region where a magnet contacts the stator laminations. In this position the hall sensor only detects a small portion of permanent magnet fringing flux that varies in magnitude with rotor position. The output of the hall sensor is a sinusoidal like waveform that corresponds to the degree of overlap of the stator and rotor poles based upon the displacement of the magnetic field of the permanent magnets. By controlling a reference voltage on one of the inputs of the op amp comparator and placing the signal of the hall sensor on the other input to the op amp comparator, the output of the op amp comparator can be set to correspond repeatedly to the same rotor angular position. Precision control of motor startup and continuous operation can be implemented using three op amps comparators. The first op amp comparator is set to correspond to the point where the rotor and stator poles move in and out of alignment. The second op amp comparator is set to correspond to some angular rotor displacement to one side of the alignment of the rotor and stator poles, and the third op amp comparator is set to correspond to some angular rotor displacement to the other side of alignment of the rotor and stator poles. The three signals can be fed to a controller to provide control of the electro-mechanical device at start up and in operation. The controller for the electro-mechanical device can also include a feedback loop. By adding a feedback loop regarding the reference voltage inputs of the comparators and allowing the controller to adjust the reference voltages based on speed and load (current), total dynamic control of the device over its operating range is achievable.

A highly efficient electro-mechanical device can be designed by placing the stator poles in an angular spaced manner to produce the greatest possible pole arc and pole area with the least number of phase switching periods per revolution. Addition efficiency gains can be obtained by controlling the current in a control coil within each single switching event. A single switching event is defined as the period when a rotor and stator pole is fully unaligned and current is applied to a control coil in a direction to move the field of the permanent magnets to produce a torque on the unaligned poles to bring the poles into alignment, or the advancement of one rotor pole.

Three methods to dynamically control the current through a control coil during each switching event are disclosed. The control coil current control methods make use of available current sensing devices, such as measuring the voltage drop across a resistor placed in series with a control coil, or measuring the magnetic field surrounding a power lead to a control coil such as a current transformer or linear hall effect sensor or switch. These devices normally will provide a voltage signal, in an analog or digital form, that is proportional to the current flowing through the circuit they are monitoring.

The first current control method controls the control coil current using a maximum current limit setting. When this setting is exceeded, a signal is generated by the current sensor which is used by the controller to turn off the power switches to the control coil. The control coil is turned back on when the current drops below the maximum current setting. In this method current is not controlled unless it exceeds some maximum limit, however this maximum limit can be dynamically changed by the controller based upon a known motor current operating profile. In some embodiments, when the current exceeds the maximum current limit a pseudo pulse width modulation control of the control coil current is used. By using pulse width modulation, which is characterized by turning switches to the control coils on and office with some predetermined frequency, current can be controlled. This may be desirable to a simple turning off of the switches coupled to the control coils.

The second current control method utilizes a known motor operating profile and the profile of the torque produced per amp as a rotor and stator pole moves angularly from a non-aligned to an aligned position. For a given motor size design, the no load speed and no load current is known and as the motor is loaded the speed and current is know for each speed to load [torque] points down to zero rpm. By monitoring the rotor speed, the load at that point and the required current to support that load is known from the pre-measured operating profile. The known required current for a given load combined with the profile of the torque produced per amp gives the resultant current at a given load and at a given rotor angular position. Using one of the aforementioned current sensor methods, the control coil current is regulated to match the control coil current being measured to the known current value for a particular load and rotor angular position.

The third current control method measures the magnetic flux across the air gap of the rotor and stator poles moving out of alignment [flux 1] and the rotor and stator poles moving into alignment [flux 2]. Since some embodiments of electro-mechanical device disclosed use control coil coupling with the permanent magnet across the aligned stator and rotor poles and moving this flux and placing in parallel with the non-aligned rotor and stator poles, the correct amount of current allowed to flow through the control coil at any given angular rotor position is based upon the differential of flux 1 and flux 2. The measurement of flux 1 and flux 2 can be provided by using a hall sensor placed adjacent to the stator laminations in a region where a magnet contacts the stator laminations using comparator circuitry. Based upon the output of the hall sensor circuitry, the control coil current is regulated to adjust the magnetic flux differential being measured to an optimized value for that exact rotor angular position.

The following table provides angular spacing examples for various electro-mechanical devices. The angular spacing relates to the number of magnets in the stator, stator and rotor pole arc and the number of switching periods required for the rotor to rotate one revolution.

| | | | |
|---|---|---|---|
| Magnets In Stator | 2 | 4 | 6 |
| Disclosed Spacing Pole Arc | 36 deg | 18 deg | 12 |
| Equal Spacing Pole Arc | 30 deg | 15 deg | 10 |
| Disclosed Spacing Switching Periods | 10 | 20 | 30 |
| Equal Spacing Switching Periods | 12 | 24 | 36 |

The electro-mechanical device includes compensation windings coiled around each of the stator poles in an embodiment. The compensation windings control the excessive fringing flux produced by a stator permanent magnet while the stator permanent magnet is not being coupled to a control coil. The control coil placed between the poles on a stator segment performs flux steering of the permanent magnet flux, while the compensation windings are used to reduce fringing flux. The current in the control coils placed between the poles on a stator segment reverses polarity every other switching period, but the compensation windings are only energized with the current flowing one direction and only to the necessary magnitude in amp turns to reduce the fringing flux. The compensation windings are only energized for the stator poles associated with a permanent magnet not magnetically coupled to a winding placed between the poles of a stator segment. The magnitude of the current, in amp turns, in a compensation winding can be a function of the current in the control coil placed between the poles on a stator segment. The current in the compensation winding can also be controlled by a hall sensor placed on the stator segment in the vicinity of a permanent magnet to measure the fringing flux and control the energizing of a compensation winding.

The materials used for the rotor and stator segments such as stator segment 1 and rotor 4 in FIG. 1, and the other various stator and rotor segments shown in the additional figures are composed of a magnetically soft material. Magnetically soft materials are materials that are easily magnetized when a magnetizing field is applied and retain substantially no magnet field once the magnetizing force is removed. This magnetically soft material can be a solid material but normally to reduce eddy currents and core losses the magnetically soft material is either laminated or used in particle form and held together with a bonding material or sintered. The embodiments disclosed are not limited to any particular magnetically soft material.

The materials used for the permanent magnets such as the permanent magnets 2 in FIG. 1, and the other various permanent magnets shown in the additional figures are composed of a magnetically hard material. Magnetically hard materials are materials that sustain a substantial magnetic field after a magnetizing field has been applied and then removed. There are many magnetically hard materials, such as neodymium, samarium cobalt, Alnico, and other compositions. The embodiments disclosed are not limited to any particular magnetically hard material.

The reluctance gap discussed above can be applied to any of the embodiments discussed and be sized according to the application. This sizing can range from there being no reluctance gap to the reluctance gap being so large that no flux from the permanent magnet can traverse the reluctance gap.

In the various embodiments disclosed, the control coils can be wired in various series and series parallel configurations. Each different wiring configuration provides varying amounts of current flow. For example, when the control coils are wired in series less current flows through each than if the coils are wired in a fully parallel configuration. The wiring configurations can be changed using switches, as disclosed above. In an embodiment where the wiring configurations are changeable, the configuration can be used to match the load on the electro-mechanical device. For traction applications this can be used to provide more torque at start-up than after a constant speed is attained. The wiring configurations can also be used in generators, for example, a wind turbine where the external torque can vary.

An electro-mechanical device is constructed in one embodiment where stator segments circumscribe a portion of the rotor. The stator segments need not circumscribe the entire rotor. Such an electro-mechanical device can be useful in certain applications where space constraints pose a problem. The windings are referred to as control coils in this description since they control the flux from permanent magnets, but they could also be referred to as phase coils or just coils that carry an electrical current to produce a magnetic field. It should be understood that there is no limit to the number of poles used greater than two and that an odd or even amount of poles can be used. The controller, sensor, and/or series/parallel switch control can be implemented with circuits, a microprocessor, or mechanically depending on the embodiment. The power switches of the various embodiments may be any electrical or semiconductor switch such as a power metal-oxide-semiconductor field effect transistor (MosFet), an insulated gate bipolar transistor (IGBT), power junction field effect transistors, or Mos-controlled thyristors, for example. Other embodiments are within the scope of the following claims.

I claim:

1. An electro-mechanical device comprising:
a rotor having a plurality of poles arranged about a central axis of rotation; and
a stator aligned with the rotor and including a first stator segment, a second stator segment, and a permanent magnet which has north and south pole faces and is positioned between the first and second stator segments,
wherein the first stator segment includes a left section, a right section, and a bridge section separating the left and right sections of the first stator segment, wherein the right section of the first stator segment is adjacent to a first pole face of the first permanent magnet and includes a first reluctance bridge extension and includes a stator pole that extends towards the rotor,
wherein the second stator segment includes a left section, a right section, and a bridge section separating the right and left section of the second stator segment, wherein the left section of the second stator segment is adjacent to a second pole face of the first permanent magnet and includes a second reluctance bridge extension and includes a stator pole that extends towards the rotor, and
wherein the first and second reluctance bridge extensions extend towards each other and provide a magnetic flux path bridging the north and south poles of the first permanent magnet.

2. The electro-mechanical device of claim 1, wherein the first and second reluctance bridge extensions are separated from each other by a gap

3. The electro-mechanical device of claim 1, wherein the first and second reluctance bridge extensions are in contact with each other.

4. The electro-mechanical device of claim 3, where the first and second reluctance bridge extensions are formed as a unitary structure

5. The electro-mechanical device of claim 1, further comprising a reluctance bridge coil surrounding at least one of the first and second reluctance bridge extensions.

6. The electro-mechanical device of claim 5, further comprising a reluctance gap controller coupled to the reluctance bridge coil and for controlling the reluctance of the magnetic flux path formed by the first and second reluctance bridge extensions.

7. The electro-mechanical device of claim 1, wherein each of the first and second stator segments also includes a control coil wound around the stator segment bridge section.

8. The electro-mechanical device of claim 1, wherein the stator circumscribes the rotor.

9. The electro-mechanical device of claim 1, wherein the left section of the first stator segment includes a stator pole that extends towards the rotor and a reluctance bridge extension that is identical to the second reluctance bridge extension, and wherein the right section of the second stator segment includes a stator pole that extends towards the rotor and a reluctance bridge extension that is identical to the first reluctance bridge extension.

10. The electro-mechanical device of claim 1, wherein the permanent magnet is located between the first and second reluctance bridge extensions on one side and the rotor on the other.

11. An electro-mechanical device comprising:
a rotor having a plurality of poles arranged about a central axis of rotation; and
a stator aligned with the rotor and including a plurality of stator segments arranged on a path that circumscribes the central axis of rotation, said stator also including a plurality of permanent magnets, each of which has north and south pole faces and is positioned between a different pair of stator segments among the plurality of stator segments, wherein the permanent magnets are serially arranged along the path with pole faces oriented north to north and south to south,
wherein the plurality of stator segments includes a first stator segment and a second stator segment and a first permanent magnet between the first and second stator segments,
wherein the first stator segment includes a left section, a right section, and a bridge section separating the right and left sections of the first stator segment, wherein the right section of the first stator segment is adjacent to a first face of the first permanent magnet and includes a first reluctance bridge extension and a stator pole that extends towards the rotor,
wherein the second stator segment includes a left section, a right section, and a bridge section separating the right and left sections of the second stator segment, wherein the left section of the second stator segment is adjacent to a second face of the first permanent magnet and includes a second reluctance bridge extension and a stator pole that extends towards the rotor, and
wherein the first and second reluctance bridge extensions extend toward each other and provide a path for a portion of the magnetic flux of the first permanent magnet to flow between the first and second stator segments.

12. An electro-mechanical device comprising:
a rotor having a plurality of poles arranged about a central axis of rotation;
a stator including a plurality of stator segments arranged on a path that circumscribes the axis of rotation, said stator also including a plurality of permanent magnets, each of which has north and south pole faces and is positioned between a different pair of stator segments among the plurality of stator segments, wherein each stator segment has at least two stator poles extending toward the rotor; and
a sensor mounted near a selected one of the plurality of permanent magnets for detecting during operation changes in a magnetic flux produced by that selected permanent magnet.

13. The electro-mechanical device of claim 12, wherein each stator segment also includes a control coil for generating a magnetic field within that stator segment, and wherein the device further comprises a controller circuit which receives a signal derived from the sensor and during operation of the device controls a voltage or current that is supplied to the control coils of the stator segments.

14. An electro-mechanical device comprising:
a rotor having a plurality of poles arranged about a central axis of rotation;
a stator including a plurality of poles extending toward the rotor;
a plurality of permanent magnets; and
a sensor mounted near a selected one of the permanent magnets for detecting changes in flux produced by the selected permanent magnet during operation of the device.

15. An electro-mechanical device comprising:
a rotor having a plurality of poles arranged about a central axis of rotation; and
a stator including N stator segments arranged on a path that circumscribes the axis of rotation, said stator also including N permanent magnets, each of which has north and south pole faces and is positioned between a different pair of stator segments among the N stator segments, wherein each stator segment comprises two stator poles joined by a bridge section and a coil wound around the bridge section, wherein the two stator poles of each stator segment extend toward the rotor, wherein the N permanent magnets are serially arranged in the stator with pole faces aligned north to north and south to south, and wherein N is an even integer that is greater than 2.

16. An electro-mechanical device comprising:
a rotor having a plurality of poles arranged about a central axis of rotation; and
a stator including N stator segments arranged on a circle that circumscribes the axis of rotation, said stator also including N permanent magnets, each of which has north and south pole faces and is positioned between a different pair of stator segments among the N stator segments, wherein each stator segment has two stator poles that extend toward the rotor and a coil wound around each of the two stator poles, wherein the N permanent magnets are serially arranged in the stator with pole faces aligned north to north and south to south, wherein N is an even integer that is greater than 1, and wherein the poles of the plurality of segments are arranged around the axis of rotation with unequal angular spacing.

17. An electro-mechanical device comprising:
a rotor having a plurality of poles arranged about a central axis of rotation; and
a stator including N stator segments arranged on a circle that circumscribes the axis of rotation, said stator also including N permanent magnets, each of which has north and south pole faces and is positioned between a different pair of stator segments among the N stator segments, wherein each stator segment comprises two stator poles joined by a bridge section, a coil wound around each of the two stator poles of that stator segment, and a coil wound around the bridge section, wherein the two stator poles of each stator segment extend toward the rotor, wherein the N permanent magnets are serially arranged in the stator with pole faces aligned north to north and south to south, and wherein N is an even integer that is greater than 1.

18. An electro-mechanical device comprising:
a rotor having a plurality of poles arranged about a central axis of rotation; and
a stator including a first stator segment and a second stator segment and a permanent magnet between the first and second stator segments, wherein each of the first and second stator segments includes two poles extending toward the rotor and a bridge section joining the two poles, the stator further comprising an insulating structure that thermally or electrically isolates the permanent magnet from the first and second stator segments relative to an arrangement in which the permanent magnet directly contacts the first and second stator segments.
